(19) United States
(12) Patent Application Publication
(10) Pub. No.: US 2023/0244974 A1
(43) Pub. Date: Aug. 3, 2023

(54) QUANTUM STATE PROCESSING METHOD, COMPUTING DEVICE AND STORAGE MEDIUM

(71) Applicant: Beijing Baidu Netcom Science Technology Co., Ltd., Beijing (CN)

(72) Inventors: Kun FANG, Beijing (CN); Xin WANG, Beijing (CN)

(21) Appl. No.: 17/929,575

(22) Filed: Sep. 2, 2022

(30) Foreign Application Priority Data
Jan. 28, 2022 (CN) 202210105352.8

(51) Int. Cl. G06N 10/20; G06N 10/80

(52) U.S. Cl. CPC G06N 10/20; G06N 10/80

(57) ABSTRACT

A quantum state processing method, a computing device and a storage medium. The method includes: acquiring a first group of measurement results for a first quantum state ρ, the first group of measurement results including a measurement result for the first quantum state ρ and a measurement result for an approximate n-order quantum state ρ^{[n]}; acquiring a second group of measurement results for a second quantum state σ, the second group of measurement results including a measurement result for the second quantum state σ and a measurement result for an approximate m-order quantum state σ^{[m]}; obtaining, based on at least the first group of measurement results and the second group of measurement results, a target high-order inner product tr(ρⁿσ^{m}) for the first quantum state ρ and the second quantum state σ; and the ρⁿ characterizing an n-order quantum state of the first quantum state σ.

### CROSS-REFERENCE TO RELATED APPLICATIONS

The present application claims the priority from Chinese Patent Application No. 202210105352.8, filed with the Chinese Patent Office on Jan. 28, 2022, the content of which is hereby incorporated herein by reference in its entirety.

### TECHNICAL FIELD

The present disclosure relates to a field of data processing technology, and in particular, to a field of quantum computing.

### BACKGROUND

With recent breakthroughs in theories and experiments, different types of small and medium-sized quantum computers have appeared all over the world. How to perform distributed computing on different quantum computers has become a core problem.

### SUMMARY

The present disclosure provides a quantum state processing method, a computing device, a computing apparatus and a storage medium.

According to one aspect of the present disclosure, provided is a quantum state processing method, applied to a first quantum computing device, including: performing a first quantum operation on a first auxiliary quantum bit in a first preset quantum circuit; where the first preset quantum circuit includes at least the first auxiliary quantum bit, a first group of quantum bits and at least one second group of quantum bits; the first group of quantum bits forming a first quantum state ρ, and a second group of quantum bits forming the first quantum state ρ; performing a second quantum operation on the first auxiliary quantum bit, the first group of quantum bits and an i-th second group of quantum bits in the at least one second group of quantum bits, in a case where the first quantum operation is completed; the i being a positive integer greater than or equal to 1 and less than or equal to n−1, and the n being a positive integer greater than or equal to 2; and performing the first quantum operation on the first auxiliary quantum bit again, in a case where the second quantum operation is performed n−1 times, and taking a quantum state formed by the current first group of quantum bits as an approximate n-order quantum state ρ^{[n]} of the first quantum state ρ, in a case where the current first auxiliary quantum bit satisfies a preset condition.

According to another aspect of the present disclosure, provided is a quantum state processing method, applied to a second quantum computing device, including: performing a third quantum operation on a second auxiliary quantum bit in a second preset quantum circuit; where the second preset quantum circuit includes at least the second auxiliary quantum bit, a third group of quantum bits and at least one fourth group of quantum bits; the third group of quantum bits forming a second quantum state σ, and a fourth group of quantum bits forming the second quantum state σ; performing a fourth quantum operation on the second auxiliary quantum bit, the third group of quantum bits and a j-th fourth group of quantum bits in the at least one fourth group of quantum bits, in a case where the third quantum operation is completed; the j being a positive integer greater than or equal to 1 and less than or equal to m−1, and the m being a positive integer greater than or equal to 2; and performing the third quantum operation on the second auxiliary quantum bit again, in a case where the fourth quantum operation is performed m−1 times, and taking a quantum state formed by the current third group of quantum bits as an approximate m-order quantum state σ^{[m]} of the second quantum state σ, in a case where the current second auxiliary quantum bit satisfies a preset condition.

According to yet another aspect of the present disclosure, provided is a quantum state processing method, applied to a classical computing device, including: acquiring, by the classical computing device, a first group of measurement results for a first quantum state ρ, where the first group of measurement results includes a measurement result for the first quantum state ρ and a measurement result for an approximate n-order quantum state ρ^{[n]} of the first quantum state ρ, the approximate n-order quantum state ρ^{[n]} being an approximate high-order quantum state of the first quantum state ρ prepared by a first quantum computing device; acquiring, by the classical computing device, a second group of measurement results for a second quantum state σ, where the second group of measurement results includes a measurement result for the second quantum state σ and a measurement result for an approximate m-order quantum state σ^{[m]} of the second quantum state σ, the approximate m-order quantum state σ^{[m]} being an approximate high-order quantum state of the second quantum state σ prepared by a second quantum computing device; and obtaining, by the classical computing device, based on at least the first group of measurement results and the second group of measurement results, a target high-order inner product tr(ρⁿσ^{m}) for the first quantum state ρ and the second quantum state σ; where the ρⁿ characterizes an n-order quantum state of the first quantum state σ, and the σ^{[m]} characterizes an m-order quantum state of the second quantum state σ; the n being a positive integer greater than or equal to 2, and the m being a positive integer greater than or equal to 2.

According to yet another aspect of the present disclosure, provided is a first quantum computing device, including: a first quantum operation unit configured to perform a first quantum operation on a first auxiliary quantum bit in a first preset quantum circuit; where the first preset quantum circuit includes at least the first auxiliary quantum bit, a first group of quantum bits and at least one second group of quantum bits; the first group of quantum bits forming a first quantum state ρ, and a second group of quantum bits forming the first quantum state ρ; a second quantum operation unit configured to perform a second quantum operation on the first auxiliary quantum bit, the first group of quantum bits and an i-th second group of quantum bits in the at least one second group of quantum bits, in a case where the first quantum operation is completed; the i being a positive integer greater than or equal to 1 and less than or equal to n−1, and the n being a positive integer greater than or equal to 2; and a first high-order quantum state extraction unit configured to perform the first quantum operation on the first auxiliary quantum bit again, in a case where the second quantum operation is performed n−1 times, and take a quantum state formed by the current first group of quantum bits as an approximate n-order quantum state ρ^{[n]} of the first quantum state ρ, in a case where the current first auxiliary quantum bit satisfies a preset condition.

According to yet another aspect of the present disclosure, provided is a second quantum computing device, including: a third quantum operation unit configured to perform a third quantum operation on a second auxiliary quantum bit in a second preset quantum circuit; where the second preset quantum circuit includes at least the second auxiliary quantum bit, a third group of quantum bits and at least one fourth group of quantum bits; the third group of quantum bits forming a second quantum state σ, and a fourth group of quantum bits forming the second quantum state σ; a fourth quantum operation unit configured to perform a fourth quantum operation on the second auxiliary quantum bit, the third group of quantum bits and a j-th fourth group of quantum bits in the at least one fourth group of quantum bits, in a case where the third quantum operation is completed; the j being a positive integer greater than or equal to 1 and less than or equal to m−1, and the m being a positive integer greater than or equal to 2; and a second high-order quantum state extraction unit configured to perform the third quantum operation on the second auxiliary quantum bit again, in a case where the fourth quantum operation is performed m−1 times, and take a quantum state formed by the current third group of quantum bits as an approximate m-order quantum state σ^{[m]} of the second quantum state σ, in a case where the current second auxiliary quantum bit satisfies a preset condition.

According to yet another aspect of the present disclosure, provided is a classical computing device, including: a first acquisition unit configured to acquire a first group of measurement results for a first quantum state ρ, where the first group of measurement results includes a measurement result for the first quantum state ρ and a measurement result for an approximate n-order quantum state ρ^{[n]} of the first quantum state ρ, the approximate n-order quantum state ρ^{[n]} being an approximate high-order quantum state of the first quantum state ρ prepared by a first quantum computing device; a second acquisition unit configured to acquire a second group of measurement results for a second quantum state σ, where the second group of measurement results includes a measurement result for the second quantum state σ and a measurement result for an approximate m-order quantum state σ^{[m]} of the second quantum state σ, the approximate m-order quantum state of σ^{[m]} being an approximate high-order quantum state of the second quantum state σ prepared by a second quantum computing device, and a computing unit configured to obtain, based on at least the first group of measurement results and the second group of measurement results, a target high-order inner product tr(ρⁿσ^{m}) for the first quantum state ρ and the second quantum state σ; where the ρⁿ characterizes an n-order quantum state of the first quantum state σ, and the σ^{[m]} characterizes an m-order quantum state of the second quantum state σ; the n being a positive integer greater than or equal to 2, and the m being a positive integer greater than or equal to 2.

According to yet another aspect of the present disclosure, provided is a quantum computing device, the quantum computing device including: at least one quantum processing unit (QPU); and a memory coupled to the at least one QPU and configured to store an executable instruction, where the instruction, when executed by the at least one quantum processing unit, enables the at least one quantum processing unit to execute the method described above applied to a first quantum computing device or a second quantum computing device.

According to yet another aspect of the present disclosure, provided is a classical computing device, the classical computing device including: at least one processor; and a memory connected in communication with the at least one processor, where the memory stores an instruction executable by the at least one processor, and the instruction, when executed by the at least one processor, enables the at least one processor to execute the method described above applied to a classical computing device.

According to yet another aspect of the present disclosure, provided is a computing apparatus, including: the first quantum computing device described above and the classical computing device described above; or including the second quantum computing device described above and the classical computing device described above.

According to yet another aspect of the present disclosure, provided is a non-transitory computer-readable storage medium storing a computer instruction thereon, where the computer instruction is used to cause a computer to execute the method described above applied to a classical computing device.

According to yet another aspect of the present disclosure, provided is a non-transitory computer-readable storage medium storing a computer instruction thereon, where the computer instruction, when executed by at least one quantum processing unit, enables the at least one quantum processing unit to execute the method described above applied to a first quantum computing device or a second quantum computing device.

According to yet another aspect of the present disclosure, provided is a computer program product including a computer program, the computer program implements the method described above applied to a classical computing device, when executed by a processor; or the computer program implements the method described above applied to a first quantum computing device or a second quantum computing device, when executed by at least one quantum processing unit.

In this way, provided is a specific and feasible solution for estimating a high-order inner product, which provides a technical support for better exerting the ability of a plurality of quantum computers to complete problem solving of a larger scale.

It should be understood that the content described in this part is not intended to identify critical or essential crucial or important features of the embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic diagram 1 of an implementation flow of a quantum state processing method according to embodiments of the present disclosure.

FIG. 2 is a schematic diagram 2 of an implementation flow of a quantum state processing method according to embodiments of the present disclosure.

FIG. 3 is a structural diagram 1 of a first preset quantum circuit in one specific example of a quantum state processing method according to embodiments of the present disclosure.

FIG. 4 is a structural diagram 2 of a first preset quantum circuit in one specific example of a quantum state processing method according to embodiments of the present disclosure.

FIG. 5 is a structural diagram 3 of a first preset quantum circuit in one specific example of a quantum state processing method according to embodiments of the present disclosure.

FIG. 6 is a schematic diagram 3 of an implementation flow of a quantum state processing method according to embodiments of the present disclosure.

FIG. 7 is a structural diagram 1 of a second preset quantum circuit in one specific example of a quantum state processing method according to embodiments of the present disclosure.

FIG. 8 is a structural diagram 2 of a second preset quantum circuit in one specific example of a quantum state processing method according to embodiments of the present disclosure.

FIG. 9 is a structural diagram 3 of a second preset quantum circuit in one specific example of a quantum state processing method according to embodiments of the present disclosure.

FIG. 10 is a structural diagram of a first quantum computing device according to embodiments of the present disclosure.

FIG. 11 is a structural diagram of a second quantum computing device according to embodiments of the present disclosure.

FIG. 12 is a structural diagram of a classical computing device according to embodiments of the present disclosure.

FIG. 13 (a) and FIG. 13 (b) are structural diagrams of a computing apparatus according to embodiments of the present disclosure.

FIG. 14 is a block diagram of an electronic device for implementing a quantum processing method applied to a classical computing device according to embodiments of the present disclosure.

### DETAILED DESCRIPTION

The exemplary embodiments of the present disclosure are described below with reference to the accompanying drawings, including various details of the embodiments of the present disclosure to facilitate understanding, and should be considered as merely exemplary. Therefore, those of ordinary skill in the art should realize that various changes and modifications may be made to the embodiments described herein without departing from the scope and spirit of the present disclosure. Likewise, for clarity and conciseness, descriptions of well-known functions and structures are omitted in the following description.

At the early stage of the development of current quantum networks, quantum channels with high fidelity and efficient quantum transmission solutions are not mature, and distributed computing based on quantum communication still faces some challenges in physical implementation. Therefore, it is particularly important to consider distributed quantum computing without quantum communication, which can better exert the ability of a plurality of quantum computers to complete problem solving of a larger scale.

Distributed quantum computing refers to making full use of a plurality of quantum computers for quantum computing, which is a problem that must be considered for some tasks (for example, tasks such as performing cross verification between different quantum computers). On this basis, the present disclosure provides a distributed computing solution, which does not need quantum communication between two quantum computers, and only requires some simple local quantum operations to obtain a high-order inner product of two quantum states. Therefore, on the one hand, the present disclosure is feasible, for example, it may be physically implemented at the current stage; on the other hand, calculating the high-order inner product of two quantum states is a basis for calculating more complex functions; for example, a general function to be calculated may be protocoled to a calculation of a high-order inner product by means of series expansion. Therefore, the present disclosure can also effectively solve the distributed computing problems of many complex functions.

Specifically, the present disclosure first prepares local quantum states based on swap tests, and then performs distributed random measurements, thereby calculating a high-order inner product of quantum states on two different quantum computers (i.e., quantum computing devices). Specifically, it is assumed that there are two quantum computing devices, one is a quantum computing device A (i.e., a first quantum computing device) and the other is a quantum computing device B (i.e., a second quantum computing device), in an example, a first quantum state ρ may be generated on the quantum computing device A and a second quantum state σ may be generated on the quantum computing device B, and in an example, the first quantum state ρ and the second quantum state—may be prepared by a series of complex quantum circuits, and the specific expression of the quantum state is unknown. Under this condition, the present disclosure may calculate a high-order inner product tr(ρⁿσ^{m}) between the two quantum states without quantum communication, where m and n are given two positive integers, and tr is a trace of a matrix.

Further, the present disclosure may be applicable to scenes such as using a plurality of quantum computers to perform distributed quantum machine learning and cross verification between quantum computers (i.e., judging whether the performances of two quantum computers are consistent with each other). For example, in the scene of quantum machine learning, a distance between different quantum states is calculated using the high-order inner product obtained in the present disclosure, and then a loss function is constructed for model training. Therefore, the distance between different quantum states obtained based on the present disclosure may also be used as an indicator to measure a learning effect in the scene of quantum machine learning. For another example, based on the calculated high-order inner product tr(ρⁿσ^{m}), the distance between the two quantum states is further estimated, and then compared with a distance between quantum states generated by the two quantum computers using the same circuit, so as to quantitatively compare and analyze the performances of the two quantum computers. Moreover, the estimation of the distance between quantum states is also widely used in quantum information processing, for example being used to measure a degree of protection of quantum data in a dynamic process, and to measure and test effects of applications such as quantum solutions and quantum state preparation.

The present disclosure is further described in detail below.

In a first aspect, the present disclosure provides a specific solution to obtain a high-order inner product (i.e., a target high-order inner product) tr(ρⁿσ^{m}) of a first quantum state ρ and a second quantum state σ.

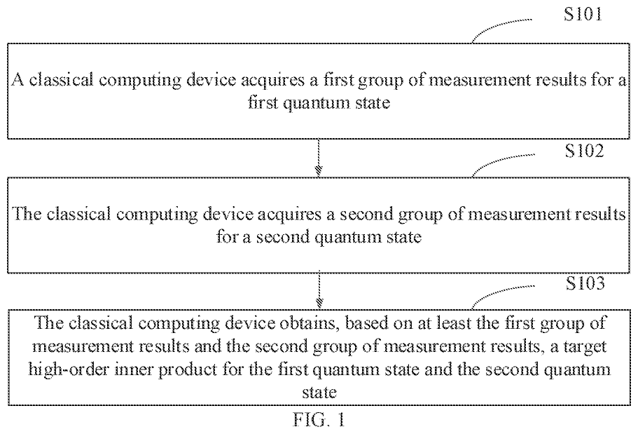

Specifically, the present disclosure provides a quantum state processing method as illustrated in FIG. 1, which is applied to a classical computing device, the method includes the followings.

In step S101, a classical computing device acquires a first group of measurement results for a first quantum state ρ, where the first group of measurement results includes a measurement result for the first quantum state ρ and a measurement result for an approximate n-order quantum state ρ^{[n]} of the first quantum state ρ, the approximate n-order quantum state ρ^{[n]} being an approximate high-order quantum state of the first quantum state ρ prepared by a first quantum computing device, and the n being a positive integer greater than or equal to 2.

In step S102, the classical computing device acquires a second group of measurement results for a second quantum state σ, where the second group of measurement results includes a measurement result for the second quantum state σ and a measurement result for an approximate m-order quantum state σ^{[m]} of the second quantum state σ, the approximate m-order quantum state σ^{[m]} being an approximate high-order quantum state of the second quantum state σ prepared by a second quantum computing device, and the m being a positive integer greater than or equal to 2.

It should be noted that in the present disclosure, either of m and n may be valued as 1 but cannot be valued as 1 at the same time. For example, n is valued as 1 and m is valued as 5. At this time, the present disclosure only needs to obtain an approximate high-order quantum state σ^{[5]} based on the following ways to estimate a high-order inner product tr(ρσ⁵). Or, m is valued as 1, and n is valued as 6. At this time, the present disclosure only needs to obtain an approximate high-order quantum state ρ^{[6]} based on the following ways to estimate a high-order inner product tr(ρ⁶σ).

In step S103, the classical computing device obtains, based on at least the first group of measurement results and the second group of measurement results, a target high-order inner product tr(ρⁿσ^{m}) for the first quantum state ρ and the second quantum state σ; where the ρⁿ characterizes an n-order quantum state of the first quantum state σ, and the σ^{m} characterizes an m-order quantum state of the second quantum state σ.

In this way, the present disclosure calculates the target high-order inner product tr(ρⁿσ^{m}) between quantum states without quantum communication between two quantum computers (i.e., the first quantum computing device and the second quantum computing device), which provides a technical support for better exerting the ability of a plurality of quantum computers to complete problem solving of a larger scale.

In one specific example of the present disclosure, the classical computing device may further obtain, based on the first group of measurement results and the second group of measurement results, at least one of the following calculation results: an inner product tr(ρσ) of the first quantum state ρ and the second quantum state σ; an inner product tr(ρσ^{[m]}) of the first quantum state ρ and the approximate m-order quantum state σ^{m}; an inner product tr(ρ^{[n]}σ) of the approximate n-order quantum state and the second quantum state σ; or an inner product tr(ρ^{[n]}σ^{[m]}) of the approximate n-order quantum state ρ^{[n]} and the approximate m-order quantum state σ^{[m]}.

Further, obtaining, based on at least the first group of measurement results and the second group of measurement results, the target high-order inner product tr(ρⁿσ^{m}) for the first quantum state ρ and the second quantum state σ specifically includes: obtaining, based on at least one of the calculation results, the target high-order inner product tr(ρⁿσ^{m}) for the first quantum state ρ and the second quantum state σ. For example, the target high-order inner product tr(ρⁿσ^{m}) is calculated based on the four inner products obtained above.

In this way, a feasible and specific computing solution is provided. Moreover, the process is implemented in a classical computing device without quantum communication, which further provides a technical support for better exerting the ability of a plurality of quantum computers to complete problem solving of a larger scale.

In one specific example of the present disclosure, in order to further improve the calculation result, i.e., an accuracy of the target high-order inner product, the classical computing device may further acquire a first probability feature and a second probability feature; here, the first probability feature characterizes a probability feature of the approximate n-order quantum state ρ^{[n]} prepared, such as a probability value of the approximate n-order quantum state ρ^{[n]} successfully prepared; and the second probability feature characterizes a probability feature of the approximate m-order quantum state σ^{[m]} prepared, such as a probability value of the approximate m-order quantum state σ^{[m]} successfully prepared.

On this basis, obtaining, based on at least the first group of measurement results and the second group of measurement results, the target high-order inner product tr(ρⁿσ^{m}) for the first quantum state ρ and the second quantum state σ includes: obtaining, based on the first probability feature, the second probability feature, the first group of measurement results and the second group of measurement results, the target high-order inner product tr(ρⁿσ^{m}) for the first quantum state ρ and the second quantum state σ.

For example, the target high-order inner product tr(ρⁿσ^{m}) for the first quantum state ρ and the second quantum state σ are calculated based on at least one of the first probability feature, the second probability feature, and the calculation results; or, based on the first probability feature, the second probability feature, and the calculation results obtained above (including the inner product tr(ρσ), the inner product tr(ρσ^{[m]}), the inner product tr(ρ^{[n]}σ), and the inner product tr(ρ^{[n]}σ^{[m]})).

In this way, a feasible and specific computing solution is further provided, and the success rate of preparing the approximate n-order quantum state ρ^{[n]} and the approximate m-order quantum state σ^{[m]} is fully considered, thereby further improving the accuracy of the calculation results.

In one specific example of the present disclosure, since the target high-order inner product is obtained, the distance between the two quantum states may be further calculated. Specifically, a target distance between the first quantum state ρ and the second quantum state σ is obtained based on at least the target high-order inner product tr(ρⁿσ^{m}). For example, a Rényi-2 distance between the first quantum state ρ and the second quantum state σ is calculated so as to measure the two quantum states.

In this way, since the present disclosure can calculate the distance between the two quantum states based on the obtained target high-order inner product, the application scene is effectively expanded. Therefore, the present disclosure has a strong practical value.

It may be understood that the approximate n-order quantum state ρ^{[n]} and the approximate m-order quantum state σ^{[m]} described in the present disclosure may be both prepared in the following way. Moreover, the classical computing device described in the present disclosure may be a classical computing unit independent of the first quantum computing device and the second quantum computing device, or a classical computing unit in the first quantum computing device, or a classical computing unit in the second quantum computing device. Further, the classical computing device may be specifically any electronic device with a classical computing function, such as a classical computer, a notebook computer, a desktop computer, and the like, which is not limited in the present disclosure.

In a second aspect, the present disclosure provides a specific solution for preparing an approximate n-order quantum state ρ^{[n]} of the first quantum state ρ in the first quantum computing device.

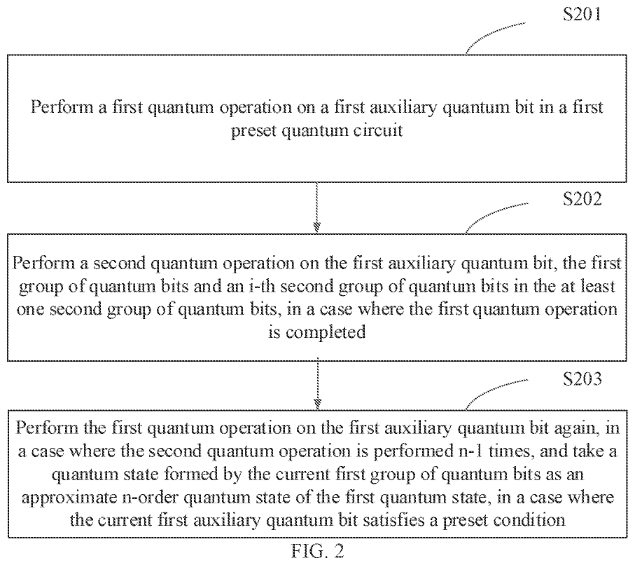

Specifically, the present disclosure provides a quantum state processing method as illustrated in FIG. 2, which is applied to a first quantum computing device, and the method includes the followings.

In step S201, a first quantum computing device performs a first quantum operation on a first auxiliary quantum bit in a first preset quantum circuit. In an example, the first preset quantum circuit includes at least the first auxiliary quantum bit, a first group of quantum bits and at least one second group of quantum bits; the first group of quantum bits forming a first quantum state ρ, and a second group of quantum bits forming the first quantum state ρ. That is, both the first group of quantum bits and the second group of quantum bits form the first quantum state ρ. In this way, a circuit support is provided to obtain an approximate high-order quantum state of the first quantum state ρ.

In step S202, the first quantum computing device performs a second quantum operation on the first auxiliary quantum bit, the first group of quantum bits and an i-th second group of quantum bits in the at least one second group of quantum bits, in a case where the first quantum operation is completed. In this way, information about the first quantum state ρ formed by the i-th second group of quantum bits is copied to the first group of quantum bits.

Here, the i is a positive integer greater than or equal to 1 and less than or equal to n−1. The n is a positive integer greater than or equal to 2.

In one specific example, the i may also be a positive integer with a value of 1 to n−1, that is, i is valued from 1 to n−1. For example, in a case of n=5, i is valued as 1, 2, 3 and 4.

In step S203, the first quantum computing device performs the first quantum operation on the first auxiliary quantum bit again, in a case where the second quantum operation is performed n−1 times, and takes a quantum state formed by the current first group of quantum bits as an approximate n-order quantum state ρ^{[n]} of the first quantum state ρ, in a case where the current first auxiliary quantum bit satisfies a preset condition.

In this way, the approximate n-order quantum state ρ^{[n]} of the first quantum state ρ may be prepared by the first quantum computing device, and quantum data support is provided to implement distributed quantum computing. Moreover, the approximate n-order quantum state ρ^{[n]} prepared by the present disclosure is prepared in the first quantum computing device based on local quantum operations, and the solution is simple and feasible.

In one specific example of the present disclosure, the first quantum operation characterizes a Hadamard gate operation; and/or, the second quantum operation characterizes a control swapping (CSWAP) gate operation (CSWAP gate operation for short). In this way, a specific local quantum operation solution is provided, which provides an operation solution for effectively accumulating the information of the quantum state on a specific qubit, and then lays a foundation for effectively obtaining an approximate n-order quantum state ρ^{[n]} of the first quantum state ρ.

In one specific example of the present disclosure, the first group of quantum bits includes d quantum bits, and the second group of quantum bits includes d quantum bits; the d being a positive integer greater than or equal to 1. That is, the first quantum state is formed by d quantum bits, and d is a positive integer greater than or equal to 1. In other words, the first quantum state is not limited in the present disclosure, i.e., it is an arbitrary quantum state. In this way, the present disclosure has strong versatility, and further lays a foundation for effectively solving the distributed computing problems of many complex functions.

In one specific example of the present disclosure, in a case where the quantity of the at least one second group of quantum bits is one, that is, the first preset quantum circuit includes one second group of quantum bits, the first preset quantum circuit contains 2d+1 qubits.

Specifically, the first auxiliary quantum bit is located in a first qubit of the 2d+1 qubits; the d quantum bits contained in the first group of quantum bits are located from a second qubit to a (d+1)-th qubit among the 2d+1 qubits; and the d quantum bits contained in the second group of quantum bits are located in last d qubits of the 2d+1 qubits.

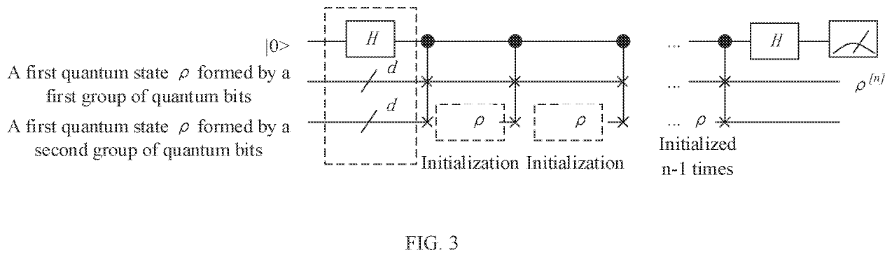

For example, as illustrated in FIG. 3, the first preset quantum circuit contains 2d+1 qubits in total. That is, the first preset quantum circuit includes a first auxiliary quantum bit, a first group of quantum bits (containing d quantum bits) and one second group of quantum bits (also containing d quantum bits), and an initial state of the first group of quantum bits is the first quantum state ρ, and an initial state of the second group of quantum bits is also the first quantum state ρ. Further, the first qubit corresponds to the first auxiliary quantum bit with an initial state as a zero state |0 [symbol] ; and the second qubit to the (d+1)-th qubit, i.e., d consecutive qubits (may be recorded as x₁x₂ . . . x_{d}) correspond to the first group of quantum bits which forms an initial state as the first quantum state ρ, and the last d consecutive qubits (may be recorded as y₁y₂ . . . y_{d}) correspond to the second group of quantum bits which forms an initial state as the first quantum state ρ.

In this way, on the basis of the first preset quantum circuit, an approximate high-order quantum state may be prepared, which provides a quantum data support for acquiring a final target high-order inner product. Moreover, since the first preset quantum circuit only contains 2d+1 qubits, a memory may also be effectively saved during the processing.

In one specific example of the present disclosure, in a case where the i is any positive integer from 2 to n−1, the method further includes: performing initialization processing on quantum bits of the last d qubits in the 2d+1 qubits, to enable a quantum state formed by the second group of quantum bits after the initialization processing to be the first quantum state ρ and take the second group of quantum bits after the initialization processing as the i-th second group of quantum bits. That is, starting from i=2, the quantum bits of the last d qubits need to be initialized, and the initialized quantum bits of the last d qubits are used as the current i-th second group of quantum bits. In this way, it is convenient to accumulate the information of the first quantum state on the qubits of the first group of quantum bits, so as to obtain an approximate high-order quantum state.

For example, an approximate high-order quantum state may be prepared in the following ways, as illustrated in FIG. 3, and specifically, the method includes the followings.

In step 1, a Hadamard gate operation is performed on the first auxiliary quantum bit; subsequently, in a case of i=1, a CSWAP gate operation is performed on quantum bits of all qubits (i.e., the first auxiliary quantum bit, the first group of quantum bits and the second group of quantum bits). For example, a CSWAP gate operation with the first auxiliary quantum bit as a control bit is performed on the first auxiliary quantum bit and quantum bits corresponding to xₗ and yₗ. Here, the xₗ characterizes an l-th quantum bit in the first group of quantum bits, and the yₗ characterizes an l-th quantum bit in the second group of quantum bits, l=1, 2, . . . , d. Therefore, the CSWAP gate operation needs to be performed d times in total.

In step 2, after the operation of step 1 is completed, i.e., in a case where the value of i is 2 to n−1, the last d consecutive qubits in 2d+1 qubits, i.e., the quantum bits on y₁y₂ . . . y_{d} are initialized, so that the quantum state of the second group of quantum bits after initialization is again changed to the first quantum state ρ, and based on the mode of step 1, the CSWAP gate operation is performed on the quantum bits of all qubits (i.e., the first auxiliary quantum bit, the first group of quantum bits and the second group of quantum bits) again. The operation mode of the CSWAP gate operation here is similar to that of the CSWAP gate operation in step 1, which will be omitted here, and this step is repeated n−2 times.

In step 3, after the operation of step 2 is completed, the Hadamard gate operation is performed on the first auxiliary quantum bit again, and a measurement under a calculation base is performed to obtain a measurement result. In a case where the measurement result satisfies the condition, the current quantum state of the first group of quantum bits is the approximate n-order quantum state ρ^{[n]} of the first quantum state ρ.

In this way, based on the preset quantum circuit and the local quantum operation, the information of the first quantum state is copied to a specific qubit, i.e., to a qubit where the first group of quantum bits is located, and then the high-order quantum state is obtained, which lays a foundation for subsequently obtaining a target high-order inner product.

In one specific example of the present disclosure, in a case where the quantity of the at least one second group of the quantum bits is n−1, that is, the first preset quantum circuit includes n−1 second group of quantum bits, the first preset quantum circuit contains nd+1 qubits; in an example, the first auxiliary quantum bit is located in a first qubit of the nd+1 qubits; the d quantum bits contained in the first group of quantum bits are located from a second qubit to a (d+1)-th qubit among the nd+1 qubits; and the i-th second group of quantum bits is located from an {id+2}-th qubit to an {(i+1)d+1}-th qubit among the nd+1 qubits.

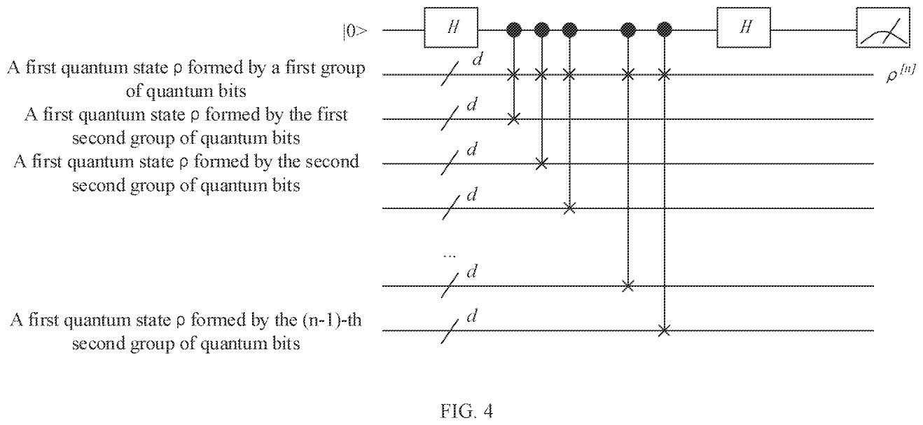

For example, as illustrated in FIG. 4, the first preset quantum circuit contains nd+1 qubits in total. That is, the first preset quantum circuit includes a first auxiliary quantum bit, a first group of quantum bits (containing d quantum bits) and n−1 second group of quantum bits (also containing d quantum bits), and an initial state of the first group of quantum bits is the first quantum state ρ, and an initial state of each second group of quantum bits is also the first quantum state ρ. Further, the first qubit corresponds to the first auxiliary quantum bit with an initial state as a zero state |0 [symbol] ; the second qubit to the (d+1)-th qubit, i.e., d consecutive qubits correspond to the first group of quantum bits which forms an initial state as the first quantum state ρ; and the (d+2)-th qubit to the (2d+1)-th qubit, i.e., d consecutive qubits correspond to a first second group of quantum bits which forms an initial state as the first quantum state ρ; further, the (2d+2)-th qubit to the (3d+1)-th qubit, i.e., d consecutive qubits correspond to a second second group of quantum bits which forms an initial state as the first quantum state ρ; by analogy, the {id+2}-th qubit to the {(i+1)d+1}-th qubit among the nd+1 qubits, i.e., d consecutive qubits correspond to an i-th second group of quantum bits which forms an initial state as the first quantum state ρ; and until the {(n−1)d+2}-th qubit to the (nd+1)-th qubit, i.e., d consecutive qubits correspond to an (n−1)-th second group of quantum bits (i.e., the last one second group of quantum bits) which forms an initial state also as the first quantum state ρ.

Further, based on the first preset quantum circuit as illustrated in FIG. 4, the approximate high-order quantum state of the first quantum state may be prepared in the following ways, as illustrated in FIG. 4. Specifically, the method includes the followings.

In step 1, a Hadamard gate operation is performed on the first auxiliary quantum bit; subsequently, a CSWAP gate operation is performed on the first auxiliary quantum bit, the first group of quantum bits, and the first second group of quantum bits; for example, a CSWAP gate operation with the first auxiliary quantum bit as the control bit is performed on the first auxiliary quantum bit and the quantum bits at the corresponding positions of the first group of quantum bits and the first second group of quantum bits.

In step 2, after the operation of step 1 is completed, the CSWAP gate operation is performed on the first auxiliary quantum bit, the first group of quantum bits and the second second group of quantum bits; for example, the CSWAP gate operation with the first auxiliary quantum bit as the control bit is performed on the first auxiliary quantum bit and the quantum bits at the corresponding positions of the first group of quantum bits and the second second group of quantum bits. By analogy, the CSWAP gate operation is performed on the first auxiliary quantum bit, the first group of quantum bits and the i-th second group of quantum bits; for example, the CSWAP gate operation with the first auxiliary quantum bit as the control bit is performed on the first auxiliary quantum bit and the quantum bits at the corresponding positions of the first group of quantum bits and the i-th second group of quantum bits; until the CSWAP gate operation is performed on the first auxiliary quantum bit, the first group of quantum bits and the (n−1)-th second group of quantum bits.

In step 3, after the CSWAP gate operation is performed on the first auxiliary quantum bit, the first group of quantum bits and the (n−1)-th second group of quantum bits, the Hadamard gate operation is performed on the first auxiliary quantum bit again, and a measurement under a calculation base is performed to obtain a measurement result. In a case where the measurement result satisfies the condition, the current quantum state of the first group of quantum bits is the approximate n-order quantum state ρ^{[n]} of the first quantum state ρ.

In this way, the present disclosure further provides a first preset quantum circuit, based on which an approximate high-order quantum state may be prepared, which provides a data support for acquiring a final target high-order inner product.

In one specific example of the present disclosure, the first preset quantum circuit contains nd+1 qubits, in a case where the quantity of the at least one second group of quantum bits is n−1; the first auxiliary quantum bit is located in a first qubit of the nd+1 qubits; the d quantum bits contained in the first group of quantum bits are located from a second qubit to a (d+1)-th qubit among the nd+1 qubits; and the i-th second group of quantum bits is located from an {(n−i)d+2}-th qubit to an {(n−i+1)d+1}-th qubit among the nd+1 qubits.

For example, as illustrated in FIG. 5, the first preset quantum circuit contains nd+1 qubits in total. That is, the first preset quantum circuit includes a first auxiliary quantum bit, a first group of quantum bits (containing d quantum bits) and n−1 second group of quantum bits (also containing d quantum bits), and an initial state of the first group of quantum bits is the first quantum state ρ, and an initial state of each second group of quantum bits is also the first quantum state ρ.

Further, the first qubit corresponds to the first auxiliary quantum bit with an initial state as a zero state |0 [symbol] ; the second qubit to the (d+1)-th qubit, i.e., d consecutive qubits correspond to the first group of quantum bits which forms an initial state as the first quantum state ρ; and the [(n−1)d+2]-th qubit to the (nd+1)-th qubit, i.e., d consecutive qubits correspond to the first second group of quantum bits which forms an initial state as the first quantum state ρ; further, the [(n−2)d+2]-th qubit to the [(n−1)d+1]-th qubit, i.e., d consecutive qubits correspond to the second second group of quantum bits which forms an initial state as the first quantum state ρ; by analogy, the {(n−i)d+2}-th qubit to a {(n−i+1)d+1}-th qubit among the nd+1 qubits, i.e., d consecutive qubits correspond to the i-th second group of quantum bits which forms an initial state as the first quantum state ρ; and until the (d+2)-th qubit to the (2d+1)-th qubit, i.e., d consecutive qubits correspond to the (n−1)-th second group of quantum bits (i.e., the last one second group of quantum bits) which forms an initial state also as the first quantum state ρ.

Further, based on the first preset quantum circuit as illustrated in FIG. 5, the approximate high-order quantum state of the first quantum state may be prepared in the following ways, as illustrated in FIG. 5. Specifically, the method includes the followings.

In step 1, a Hadamard gate operation is performed on the first auxiliary quantum bit; subsequently, a CSWAP gate operation is performed on the first auxiliary quantum bit, the first group of quantum bits, and the first second group of quantum bits; for example, a CSWAP gate operation with the first auxiliary quantum bit as the control bit is performed on the first auxiliary quantum bit and the quantum bits at the corresponding positions of the first group of quantum bits and the first second group of quantum bits.

In step 2, after the operation of step 1 is completed, a CSWAP gate operation is performed on the first auxiliary quantum bit, the first group of quantum bits and the second second group of quantum bits; for example, the CSWAP gate operation with the first auxiliary quantum bit as the control bit is performed on the first auxiliary quantum bit and the quantum bits at the corresponding positions of the first group of quantum bits and the second second group of quantum bits. By analogy, the CSWAP gate operation is performed on the first auxiliary quantum bit, the first group of quantum bits and the i-th second group of quantum bits; for example, the CSWAP gate operation with the first auxiliary quantum bit as the control bit is performed on the first auxiliary quantum bit and the quantum bits at the corresponding positions of the first group of quantum bits and the i-th second group of quantum bits; until the CSWAP gate operation is performed on the first auxiliary quantum bit, the first group of quantum bits and the (n−1)-th second group of quantum bits.

In step 3, after the CSWAP gate operation is performed on the first auxiliary quantum bit, the first group of quantum bits and the (n−1)-th second group of quantum bits, the Hadamard gate operation is performed on the first auxiliary quantum bit again, and a measurement under a calculation base is performed to obtain a measurement result. In a case where the measurement result satisfies the condition, the current quantum state of the first group of quantum bits is the approximate n-order quantum state ρ^{[n]} of the first quantum state ρ.

In this way, the present disclosure further provides a first preset quantum circuit, based on which an approximate high-order quantum state may be prepared, which provides a data support for acquiring a final target high-order inner product.

In one specific example of the present disclosure, performing the second quantum operation on the first auxiliary quantum bit, the first group of quantum bits and the i-th second group of quantum bits in the at least one second group of quantum bits, in a case where the second quantum operation characterizes a CSWAP gate operation, includes: performing the CSWAP gate operation on the first auxiliary quantum bit, the first group of quantum bits, and the i-th second group of quantum bits, using the first qubit as a control bit.

For example, for the presence of one quantum bit for both the first group of quantum bits and the second group of quantum bits, the quantum bits in the first group of quantum bits are recorded as first quantum bits, and the quantum bits in the second group of quantum bits are recorded as second quantum bits. At this time, the CSWAP gate operation may be specifically as follows: performing the CSWAP gate operation on the first auxiliary quantum bit, the first quantum bits, and second quantum bits corresponding to the i-th second group of quantum bits, using the first qubit as a control bit.

For another example, in a case where the first group of quantum bits contains d quantum bits, which may be recorded as x₁x₂ . . . x_{d}, and each second group of quantum bits also contains d quantum bits, which may be recorded as y₁y₂ . . . y_{d}, the CSWAP gate operation may be specifically as follows: performing the CSWAP gate operation on the first auxiliary quantum bit, xₗ in the first group of quantum bits, and yₗ in the i-th second group of quantum bits, using the first qubit as a control bit. Here, the xₗ characterizes an l-th quantum bit in the first group of quantum bits, and the yₗ characterizes an l-th quantum bit in the i-th second group of quantum bits, l=1, 2, . . . , d. Therefore, the CSWAP gate operation needs to be performed d times in total. In other words, the CSWAP gate operation is related to the quantities of the first group of quantum bits and the second group of quantum bits.

In this way, a feasible and specific quantum operation solution is provided, which provides a feasible operation solution for effectively accumulating the information of the quantum state on a specific qubit, and then lays a foundation for effectively obtaining the approximate n-order quantum state ρ^{[n]} of the first quantum state ρ.

In one specific example of the present disclosure, a measurement result of the first auxiliary quantum bit under a preset calculation base is obtained after the second quantum operation is performed n−1 times, and after the first quantum operation is performed on the first auxiliary quantum bit again; at this time, taking the quantum state formed by the current first group of quantum bits as the approximate n-order quantum state ρ^{[n]} of the first quantum state ρ, in the case where the current first auxiliary quantum bit satisfies the preset condition, specifically includes: taking the quantum state formed by the current first group of quantum bits as the approximate n-order quantum state ρ^{[n]} of the first quantum state ρ, in a case where the measurement result is a preset result.

For example, the initial state of the first auxiliary quantum bit is zero state |0 [symbol] . At this time, after the local quantum operation is completed, i.e., after the second quantum operation is performed n−1 times, and after the first quantum operation is performed on the first auxiliary quantum bit again, if the measurement result of the first auxiliary quantum bit obtained under the preset calculation base is 0, it indicates that the quantum state is successfully prepared. At this time, a quantum state formed by the first group of quantum bits is taken as an approximate n-order quantum state ρ^{[n]} of the first quantum state ρ.

In this way, the approximate n-order quantum state ρ^{[n]} of the first quantum state ρ may be prepared by the first quantum computing device, which provides a quantum data support to implement distributed quantum computing. Moreover, the approximate n-order quantum state ρ^{[n]} prepared by the present disclosure is prepared in the first quantum computing device based on local quantum operations, and the solution is simple and feasible.

In a third aspect, the present disclosure provides a specific solution for preparing an approximate m-order quantum state σ^{[m]} of the first quantum state σ in a second quantum computing device.

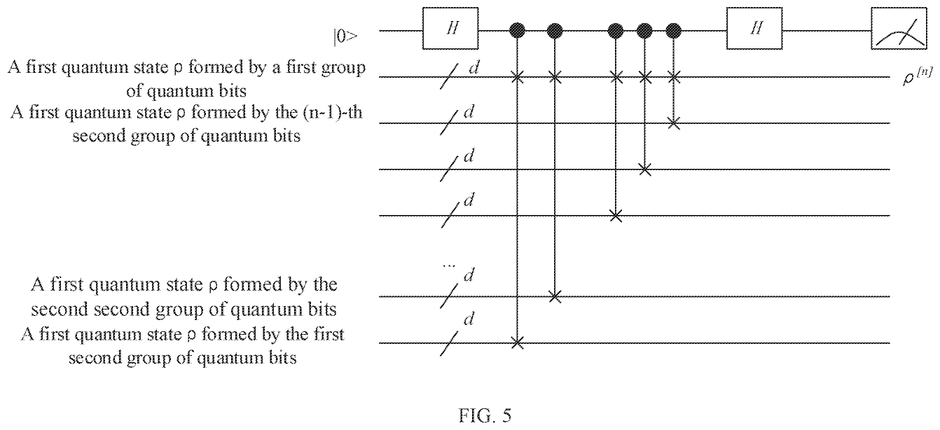

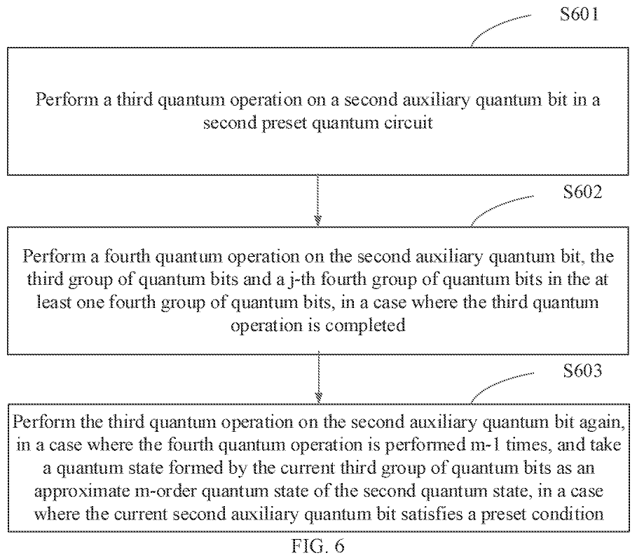

Specifically, the present disclosure further provides a quantum state processing method, applied to a second quantum computing device as illustrated in FIG. 6, and the method includes the followings.

In step S601, a second quantum computing device performs a third quantum operation on a second auxiliary quantum bit in a second preset quantum circuit; in an example, the second preset quantum circuit includes at least the second auxiliary quantum bit, a third group of quantum bits and at least one fourth group of quantum bits; the third group of quantum bits forming a second quantum state σ, and a fourth group of quantum bits forming the second quantum state σ. That is, both the third group of quantum bits and the fourth group of quantum bits form the second quantum state σ. In this way, a circuit support is provided to obtain an approximate high-order quantum state of the second quantum state σ.

In step S602, the second quantum computing device performs a fourth quantum operation on the second auxiliary quantum bit, the third group of quantum bits and a j-th fourth group of quantum bits in the at least one fourth group of quantum bits, in a case where the third quantum operation is completed. In this way, information about the second quantum state σ formed by the j-th fourth group of quantum bits is copied to the third group of quantum bits.

Here, the j being a positive integer greater than or equal to 1 and less than or equal to m−1, and the m being a positive integer greater than or equal to 2.

In one specific example, the j may also be a positive integer valued as 1 to m−1, that is, j is valued from 1 to m−1; for example, in a case of m=4, j s valued as 1, 2 and 3.

In step S603, the second quantum computing device performs the third quantum operation on the second auxiliary quantum bit again, in a case where the fourth quantum operation is performed m−1 times, and takes a quantum state formed by the current third group of quantum bits as an approximate m-order quantum state σ^{[m]} of the second quantum state σ, in a case where the current second auxiliary quantum bit satisfies a preset condition.

In this way, the approximate m-order quantum state σ^{[m]} of the second quantum state σ may be prepared by the second quantum computing device, and a quantum data support is provided to implement distributed quantum computing. Moreover, the approximate m-order quantum state σ^{[m]} prepared by the present disclosure is prepared in the second quantum computing device based on local quantum operations, and the solution is simple and feasible.

In one specific example of the present disclosure, the third quantum operation characterizes a Hadamard gate operation; and/or the fourth quantum operation characterizes a CSWAP gate operation. In this way, a specific local quantum operation solution is provided, which provides an operation solution for effectively accumulating the information of the quantum state on a specific qubit, and then lays a foundation for effectively obtaining an approximate m-order quantum state σ^{[m]} of the second quantum state σ.

In one specific example of the present disclosure, the third group of quantum bits includes b quantum bits, and the fourth group of quantum bits includes b quantum bits; the b being a positive integer greater than or equal to 1. That is, the second quantum state is formed by b quantum bits, and b is a positive integer greater than or equal to 1. In other words, the second quantum state is not limited in the present disclosure, i.e., it is an arbitrary quantum state. In this way, the present disclosure has strong versatility, and further lays a foundation for effectively solving the distributed computing problems of many complex functions.

In one specific example of the present disclosure, in a case where the quantity of the at least one fourth group of quantum bits is one, that is, the second preset quantum circuit includes one fourth group of quantum bits, the second preset quantum circuit contains 2b+1 qubits; in an example, the second auxiliary quantum bit is located in a first qubit of the 2b+1 qubits; the b quantum bits contained in the third group of quantum bits are located from a second qubit to a (b+1)-th qubit among the 2b+1 qubits; and the b quantum bits contained in the fourth group of quantum bits are located in last b qubits of the 2b+1 qubits.

For example, as illustrated in FIG. 7, the second preset quantum circuit contains 2b+1 qubits in total. That is, the second preset quantum circuit includes a second auxiliary quantum bit, a third group of quantum bits (containing b quantum bits) and one fourth group of quantum bits (also containing b quantum bits), and an initial state of the third group of quantum bits is the second quantum state σ, and an initial state of the fourth group of quantum bits is also the second quantum state σ. Further, the first qubit corresponds to the second auxiliary quantum bit with an initial state as a zero state |0 [symbol] ; and the second qubit to the (b+1)-th qubit, i.e., b consecutive qubits (may be recorded as z₁z₂ . . . z_{b}) correspond to the third group of quantum bits which forms an initial state as the second quantum state σ, and the last b consecutive qubits (may be recorded as k₁k₂ . . . k_{b}) correspond to the fourth group of quantum bits which forms an initial state as the second quantum state σ.

In this way, based on the second preset quantum circuit, an approximate high-order quantum state may be prepared, which provides a quantum data support for obtaining the final target high-order inner product. Moreover, since the second preset quantum circuit only contains 2b+1 qubits, a memory may also be effectively saved in the processing process.

In one specific example of the present disclosure, in a case where the j is any positive integer from 2 to m−1, the method further includes: performing initialization processing on quantum bits of the last b qubits in the 2b+1 qubits, to enable a quantum state formed by the fourth group of quantum bits after the initialization processing to be the second quantum state σ and take the fourth group of quantum bits after the initialization processing as the j-th fourth group of quantum bits. That is, starting from j=2, the quantum bits of the last b qubits need to be initialized. In this way, it is convenient to accumulate the information of the second quantum state on the qubits of the third group of quantum bits, so as to obtain an approximate high-order quantum state.

For example, an approximate high-order quantum state may be prepared in the following ways as illustrated in FIG. 7, and specifically, the method includes the followings.

In step 1, a Hadamard gate operation is performed on the second auxiliary quantum bit; subsequently, in a case of j=1, a CSWAP gate operation is performed on quantum bits of all qubits (i.e., the second auxiliary quantum bit, the third group of quantum bits and the fourth group of quantum bits); for example, a CSWAP gate operation with the first auxiliary quantum bit as the control bit is performed on the second auxiliary quantum bit and the quantum bits corresponding to zₚ and kₚ. Here, the zₚ characterizes a p-th quantum bit in the third group of quantum bits, and the kₚ characterizes a p-th quantum bit in the fourth group of quantum bits, p=1, 2, . . . , d. Therefore, the CSWAP gate operation needs to be performed d times in total.

In step 2, after the operation of step 1 is completed, i.e., in a case where j is valued as 2 to m−1, the last b consecutive qubits in 2b+1 qubits, i.e., the quantum bits on k₁k₂ . . . k_{b}, are initialized, so that the quantum state of the fourth group of quantum bits after initialization is again changed to the second quantum state σ, and based on the mode of step 1, the CSWAP gate operation is performed on the quantum bits of all qubits (i.e., the second auxiliary quantum bit, the third group of quantum bits and the fourth group of quantum bits) again. The operation mode of the CSWAP gate operation here is similar to that of the CSWAP gate operation in step 1, which will not be repeated here, and this step is repeated m−2 times.

In step 3, after the operation of step 2 is completed, a Hadamard gate operation is performed on the second auxiliary quantum bit again, and a measurement under a calculation base is performed to obtain a measurement result. In a case where the measurement result satisfies the condition, the current quantum state of the third group of quantum bits is the approximate m-order quantum state σ^{[m]} of the second quantum state σ.

In this way, based on the preset quantum circuit and local quantum operation, the information of the second quantum state is copied to a specific qubit, i.e., to the qubit where the third group of quantum bits is located, and then the high-order quantum state is obtained, which lays a foundation for subsequently obtaining a target high-order inner product.

In one specific example of the present disclosure, in a case where the quantity of the at least one fourth group of quantum bits is m−1, that is, the second preset quantum circuit includes m−1 fourth group of quantum bits, the second preset quantum circuit contains mb+1 qubits; in an example, the second auxiliary quantum bit is located in a first qubit of the mb+1 qubits; the b quantum bits contained in the third group of quantum bits are located from a second qubit to a (b+1)-th qubit among the mb+1 qubits; and the j-th fourth group of quantum bits is located from a {jb+2}-th qubit to a {j+1)b+1}-th qubit among the mb+1 qubits.

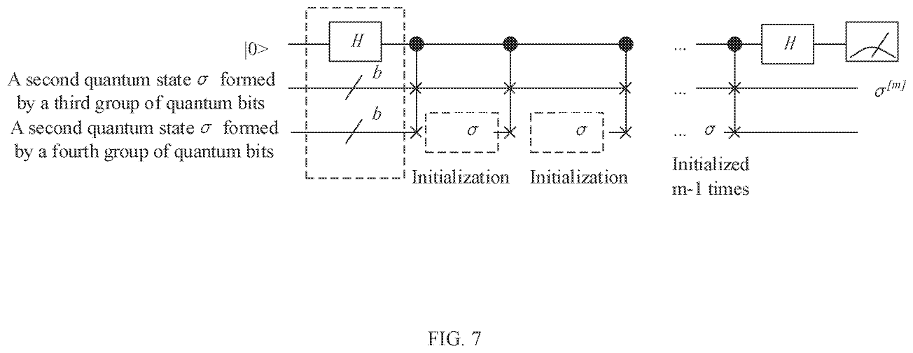

For example, as illustrated in FIG. 8, the second preset quantum circuit contains mb+1 qubits in total, that is, the second preset quantum circuit includes a second auxiliary quantum bit, a third group of quantum bits (containing b quantum bits) and m−1 fourth group of quantum bits (also containing b quantum bits), and an initial state of the third group of quantum bits is the second quantum state σ, and an initial state of each fourth group of quantum bits is also the second quantum state σ. Further, the first qubit corresponds to the second auxiliary quantum bit with an initial state as a zero state |0 [symbol] ; and the second qubit to the (b+1)-th qubit, i.e., b consecutive qubits correspond to the third group of quantum bits which forms an initial state as the second quantum state σ; the (b+2)-th qubit to the (2b+1)-th qubit, i.e., b consecutive qubits correspond to the first fourth group of quantum bits which forms an initial state as the second quantum state σ; further, the (2b+2)-th qubit to the (3b+1)-th qubit, i.e., b consecutive qubits correspond to the second fourth group of quantum bits which forms an initial state as the second quantum state σ; by analogy, the {jb+2}-th qubit to the {(j+1)b+1}-th qubit among the mb+1 qubits, i.e., b consecutive qubits correspond to the j-th fourth group of quantum bits which forms an initial state as the second quantum state σ; until the [(m−1)b+2]-th qubit to the (mb+1)-th qubit, i.e., b consecutive qubits correspond to the (m−1)-th fourth group of quantum bits (i.e., the last one fourth group of quantum bits) which forms an initial state also as the second quantum state σ.

Further, based on the second preset quantum circuit as illustrated in FIG. 8, the approximate high-order quantum state of the second quantum state may be prepared in the following ways as illustrated in FIG. 8, and specifically, the method includes the followings.

In step 1, a Hadamard gate operation is performed on the second auxiliary quantum bit; subsequently, a CSWAP gate operation is performed on the second auxiliary quantum bit, the third group of quantum bits, and the first fourth group of quantum bits; for example, a CSWAP gate operation with the second auxiliary quantum bit as the control bit is performed on the second auxiliary quantum bit and the quantum bits at the corresponding positions of the third group of quantum bits and the first fourth group of quantum bits.

In step 2, after the operation of step 1 is completed, the CSWAP gate operation is performed on the second auxiliary quantum bit, the third group of quantum bits and the second fourth group of quantum bits; for example, the CSWAP gate operation with the second auxiliary quantum bit as the control bit is performed on the second auxiliary quantum bit and the quantum bits at the corresponding positions of the third group of quantum bits and the second fourth group of quantum bits. By analogy, the CSWAP gate operation is performed on the second auxiliary quantum bit, the third group of quantum bits and a j-th fourth group of quantum bits; for example, the CSWAP gate operation with the second auxiliary quantum bit as the control bit is performed on the second auxiliary quantum bit and the quantum bits at the corresponding positions of the third group of quantum bits and a j-th fourth group of quantum bits; until the CSWAP gate operation is performed on the second auxiliary quantum bit, the third group of quantum bits and the (m−1)-th fourth group of quantum bits.

In step 3, after the CSWAP gate operation is performed on the second auxiliary quantum bit, the third group of quantum bits and the (m−1)-th fourth group of quantum bits, the Hadamard gate operation is performed on the second auxiliary quantum bit again, and a measurement under a calculation base is performed to obtain a measurement result. In a case where the measurement result satisfies the condition, the current quantum state of the third group of quantum bits is the approximate m-order quantum state σ^{[m]} of the second quantum state σ.

In this way, the present disclosure further provides a second preset quantum circuit, so that an approximate high-order quantum state may be prepared based on the second preset quantum circuit, which provides a data support for acquiring the final target high-order inner product.

In one specific example of the present disclosure, the second preset quantum circuit contains mb+1 qubits, in a case where the quantity of the at least one fourth group of quantum bits is m−1; the second auxiliary quantum bit is located in a first qubit of the mb+1 qubits; the b quantum bits contained in the third group of quantum bits are located from a second qubit to a (b+1)-th qubit among the mb+1 qubits; and the j-th fourth group of quantum bits is located from an {(m−j)b+2}-th qubit to an {(m−j+1)b+1}-th qubit among the mb+1 qubits.

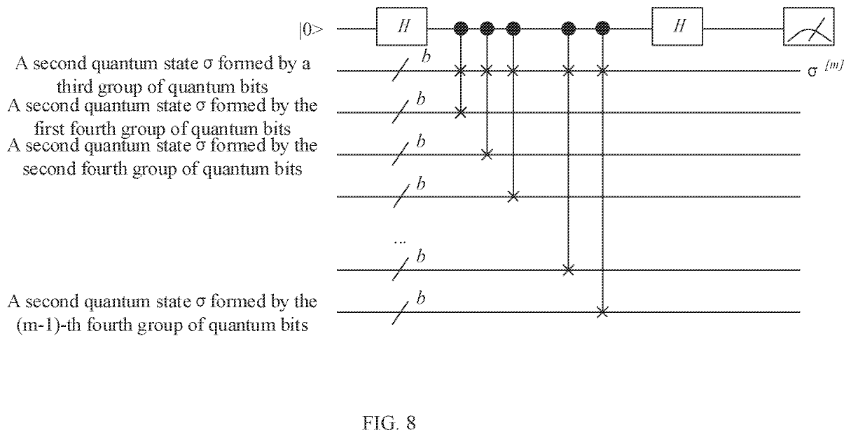

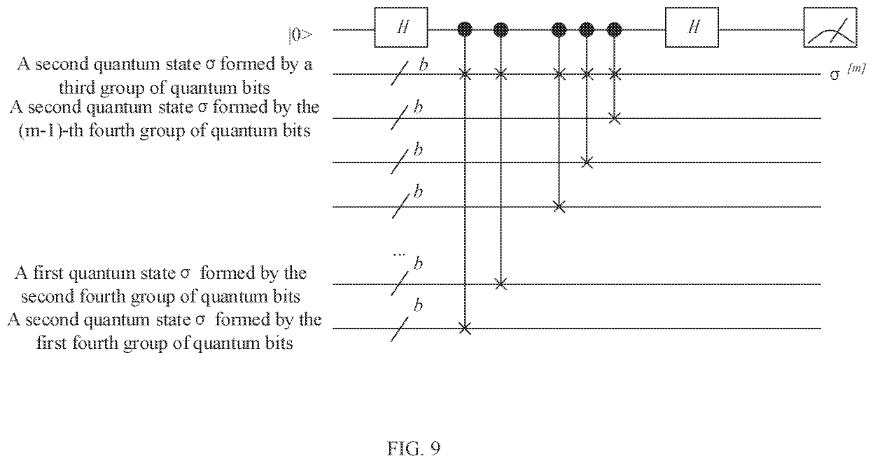

For example, as illustrated in FIG. 9, the second preset quantum circuit contains mb+1 qubits in total. That is, the second preset quantum circuit includes a second auxiliary quantum bit, a third group of quantum bits (containing b quantum bits) and m−1 fourth group of quantum bits (also containing b quantum bits), and an initial state of the third group of quantum bits is the second quantum state σ, and an initial state of each second group of quantum bits is also the second quantum state σ.

Further, the first qubit corresponds to the second auxiliary quantum bit with an initial state as a zero state |0 [symbol] ; and the second qubit to the (b+1)-th qubit, i.e., b consecutive qubits correspond to the third group of quantum bits which forms an initial state as the second quantum state σ; the [(m−1)b+2]-th qubit to the (mb+1)-th qubit, i.e., b consecutive qubits correspond to the first fourth group of quantum bits which forms an initial state as the second quantum state σ; further, the {(m−2)b+2}-th qubit to the {(m−1)b+1}-th qubit, i.e., b consecutive qubits correspond to the second fourth group of quantum bits which forms an initial state as the second quantum state σ; by analogy, the {(m−j)b+2}-th qubit to the {(m−j+1)b+1}-th qubit among the mb+1 qubits, i.e., b consecutive qubits correspond to the j-th fourth group of quantum bits which forms an initial state as the second quantum state σ; until the (b+2)-th qubit to the (2b+1)-th qubit, i.e., b consecutive qubits correspond to the (m−1)-th fourth group of quantum bits (i.e., the last one fourth group of quantum bits) which forms an initial state as also the second quantum state σ.

Further, based on the second preset quantum circuit as illustrated in FIG. 9, the approximate high-order quantum state of the second quantum state may be prepared in the following ways as illustrated in FIG. 9, and specifically, the method includes the followings.

In step 1, a Hadamard gate operation is performed on the second auxiliary quantum bit; subsequently, a CSWAP gate operation is performed on the second auxiliary quantum bit, the third group of quantum bits, and the first fourth group of quantum bits; for example, a CSWAP gate operation with the second auxiliary quantum bit as the control bit is performed on the second auxiliary quantum bit and the quantum bits at the corresponding positions of the third group of quantum bits and the first fourth group of quantum bits.

In step 2, after the operation of step 1 is completed, the CSWAP gate operation is performed on the second auxiliary quantum bit, the third group of quantum bits and the second fourth group of quantum bits; for example, the CSWAP gate operation with the second auxiliary quantum bit as the control bit is performed on the second auxiliary quantum bit and the quantum bits at the corresponding positions of the third group of quantum bits and the second fourth group of quantum bits. By analogy, the CSWAP gate operation is performed on the second auxiliary quantum bit, the third group of quantum bits and a j-th fourth group of quantum bits, for example, the CSWAP gate operation with the second auxiliary quantum bit as the control bit is performed on the second auxiliary quantum bit and the quantum bits at the corresponding positions of the third group of quantum bits and the j-th fourth group of quantum bits; until the CSWAP gate operation is performed on the second auxiliary quantum bit, the third group of quantum bits and the (m−1)-th fourth group of quantum bits.

In step 3, after the CSWAP gate operation is performed on the second auxiliary quantum bit, the third group of quantum bits and the (m−1)-th fourth group of quantum bits, the Hadamard gate operation is performed on the second auxiliary quantum bit again, and a measurement under a calculation base is performed to obtain a measurement result. In a case where the measurement result satisfies the condition, the current quantum state of the third group of quantum bits is the approximate m-order quantum state σ^{[m]} of the second quantum state Q.

In this way, the present disclosure further provides a second preset quantum circuit, so that an approximate high-order quantum state may be prepared based on the second preset quantum circuit, which provides a data support for acquiring the final target high-order inner product.

In one specific example of the present disclosure, performing the fourth quantum operation on the second auxiliary quantum bit, the third group of quantum bits and the j-th fourth group of quantum bits in the at least one fourth group of quantum bits, in a case where the fourth quantum operation characterizes a CSWAP gate operation, includes: performing the CSWAP gate operation on the second auxiliary quantum bit, the third group of quantum bits, and the j-th fourth group of quantum bits, using the first qubit as a control bit.

For example, for the presence of one quantum bit for both the third group of quantum bits and the fourth group of quantum bits, the quantum bits in the third group of quantum bits are recorded as third quantum bits, and the quantum bits in the fourth group of quantum bits are recorded as fourth quantum bits. At this time, the CSWAP gate operation may be specifically as follows: performing the CSWAP gate operation on the second auxiliary quantum bit, the third quantum bits, and fourth quantum bits corresponding to the j-th fourth group of quantum bits, using the first qubit as a control bit.

For another example, in a case where the third group of quantum bits contains d quantum bits, which may be recorded as z₁z₂ . . . z_{b}, and each fourth group of quantum bits also contains d quantum bits, which may be recorded as k₁k₂ . . . k_{b}, the CSWAP gate operation may be specifically as follows: performing the CSWAP gate operation on the second auxiliary quantum bit, zₚ in the third group of quantum bits, and kₚ in the j-th fourth group of quantum bits, using the first qubit as a control bit. Here, the zₚ characterizes a p-th quantum bit in the third group of quantum bits, and the kₚ characterizes a p-th quantum bit in the j-th fourth group of quantum bits, p=1, 2, . . . , d. Therefore, the CSWAP gate operation needs to be performed d times in total. In other words, the CSWAP gate operation is related to the quantity of the third group of quantum bits and the fourth group of quantum bits.

In this way, a feasible and specific quantum operation solution is provided, which provides a feasible operation solution for effectively accumulating the information of the quantum state on a specific qubit, and then lays a foundation for effectively obtaining the approximate m-order quantum state σ^{[m]} of the first quantum state σ.

In one specific example of the present disclosure, a measurement result of the second auxiliary quantum bit under a preset calculation base is obtained after the fourth quantum operation is performed m−1 times, and after the third quantum operation is performed on the second auxiliary quantum bit again; at this time, taking the quantum state formed by the current third group of quantum bits as the approximate m-order quantum state σ^{[m]} of the second quantum state σ, in the case where the current second auxiliary quantum bit satisfies the preset condition, specifically includes: taking the quantum state formed by the current third group of quantum bits as the approximate m-order quantum state σ^{[m]} of the second quantum state σ, in a case where the measurement result is a preset result.

For example, the initial state of the second auxiliary quantum bit is zero state |0 [symbol] . At this time, after the local quantum operation is completed, i.e., after the fourth quantum operation is performed m−1 times, and after the third quantum operation is performed on the first auxiliary quantum bit again, if the measurement result of the second auxiliary quantum bit obtained under the preset calculation base is 0, it indicates that the quantum state is successfully prepared. At this time, a quantum state formed by the third group of quantum bits is taken as an approximate m-order quantum state σ^{[m]} of the second quantum state σ.

In this way, the approximate m-order quantum state σ^{[m]} of the second quantum state σ may be prepared by the second quantum computing device, and a quantum data support is provided to implement distributed quantum computing. Moreover, the approximate m-order quantum state σ^{[m]} prepared by the present disclosure is prepared in the second quantum computing device based on local quantum operations, and the solution is simple and feasible.

The following is a further detailed description of the present disclosure in combination with specific examples, and the details are as follows.

Firstly, a computing task is clarified: it is assumed that there are two quantum computing devices, one is recorded as a quantum computing device A (i.e., a first quantum computing device) and the other is recorded as a quantum computing device B (i.e., a second quantum computing device); in an example, a first quantum state ρ may be prepared on quantum computing device A and a second quantum state σ may be prepared on quantum computing device B; in an example, the p and the a may be prepared by a series of complex quantum circuits, and the specific expression of the quantum state is unknown. On this basis, the present example hopes to calculate a target high-order internal product tr(ρⁿσ^{m}) between two quantum states (i.e., the first quantum state ρ and the second quantum state σ) without quantum communication. Here, m and n are given two positive integers, and they may be the same or different, which is not limited in the present disclosure.

Secondly, the computing task is divided into two steps.

In a first step, an approximate high-order quantum state is prepared by a swap test. For example, an approximate n-order quantum state ρ^{[n]} of the first quantum state ρ is prepared based on the first quantum computing device. Similarly, an approximate m-order quantum state σ^{[m]} of the second quantum state σ is prepared based on the second quantum computing device.

In a second step, distributed quantum computing is performed on the quantum state prepared.

Specifically, in order to estimate the target high-order inner product tr(ρⁿσ^{m}), the most direct method is to prepare quantum states ρⁿ/tr(ρⁿ) and σ^{m}/tr(σ^{m}), and then calculate an inner product of these two quantum states, but it is difficult to prepare the quantum states ρⁿ/tr(ρⁿ) and σ^{m}/tr(σ^{m}) directly. It may be understood that the computing task of the present disclosure only needs to solve the final result of the inner product. Therefore, as long as the prepared final quantum state contains copy information of a plurality of p and a plurality of a, it is possible to obtain the target high-order inner product tr(ρⁿσ^{m}). On this basis, in the present example, without preparing the quantum states ρⁿ/tr(ρⁿ) and σ^{m}/tr(σ^{m}), the mode of swap test is adopted, and a quantum operation, such as an initialization, a CSWAP gate operation, and the like, is performed on quantum bits on the corresponding qubits, so that the information of quantum states may be effectively accumulated on a specific qubit. In this way, the approximate high-order quantum states may be prepared, and then a distributed inner product algorithm may be adopted to acquire the final target high-order inner product.

The specific steps are as follows.

In a first step, an approximate high-order quantum state is prepared. In quantum computing, a swap test is often used to judge whether two quantum states are equal. There are many different variants of specific swap test methods, and the present example gives a more memory saving implementation method. Specifically, it is assumed that the first quantum state ρ contains d quantum bits, i.e., the first quantum state ρ is formed by d quantum bits (i.e., the first group of quantum bits (including d quantum bits) forms the first quantum state ρ as described above); at this time, on the quantum computing device A, the approximate n-order quantum state ρ^{[n]} of the first quantum state ρ may be prepared by the first preset quantum circuit, and the step includes the followings.

In step 1-1, a first preset quantum circuit is prepared; as illustrated in FIG. 3, the first preset quantum circuit contains 2d+1 qubits in total; that is, the first preset quantum circuit includes a first auxiliary quantum bit, a first group of quantum bits (containing d quantum bits) and one second group of quantum bits (also containing d quantum bits), and an initial state of the first group of quantum bits is the first quantum state ρ, and an initial state of the second group of quantum bits is also the first quantum state ρ. Further, the first qubit corresponds to the first auxiliary quantum bit with an initial state as a zero state |0 [symbol] ; and the second qubit to the (d+1)-th qubit, i.e., d consecutive qubits (may be recorded as x₁x₂ . . . x_{d}) correspond to the first group of quantum bits which forms an initial state as the first quantum state ρ, and the last d consecutive qubits (may be recorded as y₁y₂ . . . y_{d}) correspond to the second group of quantum bits which forms an initial state as the first quantum state ρ.

In step 1-2, a Hadamard gate operation is performed on the first auxiliary quantum bit; subsequently, a CSWAP gate operation is performed on quantum bits of all qubits (i.e., the first auxiliary quantum bit, the first group of quantum bits and the second group of quantum bits); for example, a CSWAP gate operation with the first auxiliary quantum bit as the control bit is performed on the first auxiliary quantum bit and the quantum bits corresponding to xₗ and yₗ. Here, the xₗ characterizes an l-th quantum bit in the first group of quantum bits, and the yₗ characterizes an l-th quantum bit in the second group of quantum bits, l=1, 2, . . . , d. Therefore, the CSWAP gate operation needs to be performed d times in total.

In step 1-3, after the operation of step 1-2 is completed, the last d consecutive qubits, i.e., the quantum bits on y₁y₂ . . . y_{d} are initialized, so that the quantum state of the second group of quantum bits after initialization is again changed to the first quantum state ρ, and based on the mode of step 1-2, the CSWAP gate operation is performed on the quantum bits of all qubits (i.e., the first auxiliary quantum bit, the first group of quantum bits and the second group of quantum bits) again; and this step is repeated n−2 times.

In step 1-4, after the operation of step 1-3 is completed, a Hadamard gate operation is performed on the first auxiliary quantum bit, and a measurement under a calculation base is performed to obtain a measurement result. Further, if the measurement result is 0, it indicates that the quantum state is successfully prepared. At this time, the quantum state formed by extracting the quantum bits located in the qubit x₁x₂ . . . x_{d} is the approximate n-order quantum state ρ^{[n]} of the first quantum state ρ. If the measurement result is 1, the experiment will be given up and the preparation is restarted.

Based on the same mode as above, the approximate m-order quantum state σ^{[m]} of the second quantum state σ is prepared on the quantum computing device B; specifically, it is assumed that the second quantum state σ contains b quantum bits, i.e., the second quantum state σ is formed by b quantum bits (i.e., the second group of quantum bits (including b quantum bits) forms the second quantum state σ as described above); at this time, on the quantum computing device B, the approximate m-order quantum state σ^{[m]} of the second quantum state σ may be prepared by the second preset quantum circuit, and the step includes the followings.

In step 1-5, the second preset quantum circuit is prepared; as illustrated in FIG. 6, the second preset quantum circuit contains 2b+1 qubits in total. That is, the second preset quantum circuit includes a second auxiliary quantum bit, a third group of quantum bits (containing b quantum bits) and one fourth group of quantum bits (also containing b quantum bits), and an initial state of the third group of quantum bits is the second quantum state σ, and an initial state of the fourth group of quantum bits is also the second quantum state σ. Further, the first qubit corresponds to the second auxiliary quantum bit with an initial state as a zero state |0 [symbol] ; and the second qubit to the (b+1)-th qubit, i.e., b consecutive qubits (may be recorded as z₁z₂ . . . z_{b}) correspond to the third group of quantum bits which forms an initial state as the second quantum state σ, and the last b consecutive qubits (may be recorded as k₁k₂ . . . k_{b}) correspond to the fourth group of quantum bits which forms an initial state as the second quantum state σ.

In step 1-6, a Hadamard gate operation is performed on the second auxiliary quantum bit; subsequently, a CSWAP gate operation is performed on quantum bits of all qubits (i.e., the second auxiliary quantum bit, the third group of quantum bits and the fourth group of quantum bits); for example, a CSWAP gate operation with the second auxiliary quantum bit as the control bit is performed on the second auxiliary quantum bit and the quantum bits corresponding to zₚ and kₚ. Here, the zₚ characterizes a p-th quantum bit in the third group of quantum bits, and the kₚ characterizes a p-th quantum bit in the fourth group of quantum bits, p=1, 2, . . . , d. Therefore, the CSWAP gate operation needs to be performed d times in total.

In step 1-7, after the operation of step 1-6 is completed, the last b consecutive qubits, i.e., the quantum bits on k₁k₂ . . . k_{b} are initialized, so that the quantum state of the fourth group of quantum bits after initialization is again changed to the second quantum state σ, and based on the mode of step 1-6, the CSWAP gate operation is performed on the quantum bits of all qubits (i.e., the second auxiliary quantum bit, the third group of quantum bits and the fourth group of quantum bits) again; and this step is repeated m−2 times.

In step 1-8, after the operation of step 1-7 is completed, a Hadamard gate operation is performed on the second auxiliary quantum bit, and a measurement under a calculation base is performed to obtain a measurement result. Further, if the measurement result is 0, it indicates that the quantum state is successfully prepared. At this time, the quantum state formed by extracting the quantum bits located in the qubit z₁z₂ . . . z_{b} is the approximate m-order quantum state σ^{[m]} of the second quantum state σ. If the measurement result is 1, the experiment will be given up and the preparation is restarted.

Here, it should be noted that although the preparation of the above high-order quantum states is probabilistic, it may be proved that the probability of successful preparation is strictly greater than ½. Therefore, according to Chemoff bound, in a case of a large number of experiments, the present example has a probability close to 1 to obtain at least half of the successful events.

Further, although the approximate high-order quantum ρ^{[n]} and the approximate high-order σ^{[m]} prepared by the quantum circuit illustrated in FIG. 3 or FIG. 6 are different from the desired ρⁿ/tr(ρⁿ) and σ^{m}/tr(σ^{m}), ρ^{[n]} and σ^{[m]} prepared in the present example contain a plurality of copy information of quantum states, which is sufficient to estimate the desired high-order inner product tr(ρⁿσ^{m}) to be calculated in the present example.

In a second step, distributed quantum computing is performed. Here, the distributed quantum computing in the present example may involve three devices, i.e., a first quantum computing device, a second quantum computing device and a classical computing device. It may be understood that the classical computing device in the present disclosure may be a classical computing unit independent of the first quantum computing device and the second quantum computing device, or a classical computing unit in the first quantum computing device, or a classical computing unit in the second quantum computing device. Further, the classical computing device may be specifically any electronic device with a classical computing function, such as a classical computer, a notebook computer, a desktop computer, and the like, which is not limited in the present disclosure.

In step 2-1, the above mode is adopted to prepare the approximate n-order quantum state ρ^{[n]} of the first quantum state ρ in the first quantum computing device, and prepare the approximate m-order quantum state σ^{[m]} of the second quantum state σ in the second quantum computing device.

In step 2-2, four inner products tr(ρσ), tr(ρ^{[n]}σ), tr(ρσ^{[m]}) and tr(ρ^{[n]}σ^{[m]}) are estimated by the classical computing device. It may be understood that since the first quantum state ρ, the second quantum state σ, the approximate n-order quantum state ρ^{[n]} of the first quantum state ρ, and the approximate m-order quantum state σ^{[m]} of the second quantum state σ may be prepared, the classical computing device may acquire the measurement results of the above quantum states from the quantum computing device, and the measurement results may be obtained based on the classical communication mode without quantum communication, and then the above four inner products are obtained based on the measurement results.

Step 2-2 further includes estimating the probabilities Pr (ρ^{[n]}) and Pr (σ^{[m]}) of successful preparation of quantum states through the process of quantum state preparation. Here, Pr (ρ^{[n]}) characterizes a probability of successful preparation of the approximate n-order quantum state ρ^{[n]}. Similarly, Pr (σ^{[m]}) characterizes a probability of successful preparation of the approximate m-order quantum state σ^{[m]}.

In step 2-3, the target high-order inner product tr(ρⁿσ^{m}) is estimated based on the four inner products obtained in step 2-2 and the estimated probabilities Pr (ρ^{[n]}) and Pr (σ^{[m]}).

For example, the target high-order inner product tr(ρⁿσ^{m}) is estimated based on the following formula:

tr(ρⁿσ^{m})=4Pr(ρ^{[n]})Pr(σ^{[m]})+tr(ρ^{[n]}σ^{[m]})+tr(ρσ)−2Pr(ρ^{[n]})tr(ρ^{[n]}σ)−2Pr(σ^{[m]})tr(ρσ^{[m]}).

Further, after the target high-order inner product tr(ρⁿσ^{m}) is estimated, two quantum states may be further estimated based on the target high-order inner product tr(ρⁿσ^{m}) estimated in the present example, i.e., a distance between the first quantum state ρ and the second quantum state σ.

Here, a Rényi-2 distance D₂(ρ∥σ)=log₂ tr(ρ²σ⁻¹) between two quantum states has recently been proved to be a good metric choice. However, the Rényi-2 distance cannot be effectively calculated in the prior art, because this metric is nonlinear for quantum states ρ and a. Therefore, it is difficult to calculate the Rényi-2 distance specifically. However, by using the technique of series expansion and the high-order inner product algorithm of the present disclosure, the Rényi-2 distance may be effectively estimated. Specifically, it is considered to perform the series expansion of σ⁻¹ and truncate the first k terms, Σₘ₌₀^{K}c_{K}(m)σ^{m}, where a coefficient

$${c}_{K} ( m ) = {( - 1 )}^{m} ( \begin{matrix}K + 1 \\ m + 1\end{matrix} ) ,$$

K is a specific quantity of the truncation terms, and the accuracy of the estimation increases as K becomes larger. On this basis, the Rényi-2 distance may be estimated in the following formula: log₂(Σₘ₌₀^{K}c_{K}(m)tr(ρ²σ^{m})).

Here, through the high-order inner product algorithm of the present disclosure, the value of tr(ρ²σ^{m}) may be estimated in turn, and then the Rényi-2 distance may be estimated in the above formula.

Further, the resent disclosure may reduce the function, such as the Rényi distance

$${D}_{α} ( ρ ∥ σ ) = \frac{1}{α - 1} {log}_{2} tr ( {ρ}^{α} {σ}^{1 - α} )$$

of any order, to the high-order inner product by series expansion and truncation, and then calculate the Rényi distance by invoking the high-order inner product algorithm of the present disclosure.

In this way, based on the present disclosure, a new metric estimation mode may be provided for quantum machine learning, which provides a support for obtaining different training results to satisfy the training requirements or accuracy requirements, and has richer and stronger practicability. Because a very important step in quantum machine learning is to design a loss function through a distance between two quantum data, and then perform data training according to a calculation result of the loss function, the metric mode for distances between different quantum data will achieve different training effects.

The present disclosure further provides a first quantum computing device as illustrated in FIG. 10, the device includes the followings.

A first quantum operation unit 1001 configured to perform a first quantum operation on a first auxiliary quantum bit in a first preset quantum circuit; where the first preset quantum circuit includes at least the first auxiliary quantum bit, a first group of quantum bits and at least one second group of quantum bits; the first group of quantum bits forming a first quantum state ρ, and a second group of quantum bits forming the first quantum state ρ.

A second quantum operation unit 1002 configured to perform a second quantum operation on the first auxiliary quantum bit, the first group of quantum bits and an i-th second group of quantum bits in the at least one second group of quantum bits, in a case where the first quantum operation is completed; the i being a positive integer greater than or equal to 1 and less than or equal to n−1, and the n being a positive integer greater than or equal to 2.

A first high-order quantum state extraction unit 1003 configured to perform the first quantum operation on the first auxiliary quantum bit again, in a case where the second quantum operation is performed n−1 times, and take a quantum state formed by the current first group of quantum bits as an approximate n-order quantum state ρ^{[n]} of the first quantum state ρ, in a case where the current first auxiliary quantum bit satisfies a preset condition.

In one specific example of the present disclosure, the first quantum operation characterizes a Hadamard gate operation; and/or the second quantum operation characterizes a CSWAP gate operation.

In one specific example of the present disclosure, the first group of quantum bits includes d quantum bits, and the second group of quantum bits includes d quantum bits; the d being a positive integer greater than or equal to 1.

In one specific example of the present disclosure, the first preset quantum circuit contains 2d+1 qubits, in a case where the quantity of the at least one second group of quantum bits is one; in an example, the first auxiliary quantum bit is located in a first qubit of the 2d+1 qubits; the d quantum bits contained in the first group of quantum bits are located from a second qubit to a (d+1)-th qubit among the 2d+1 qubits; and the d quantum bits contained in the second group of quantum bits are located in last d qubits of the 2d+1 qubits.

In one specific example of the present disclosure, in a case where the i is any positive integer from 2 to n−1, the second quantum operation unit is further configured to perform initialization processing on quantum bits of the last d qubits in the 2d+1 qubits, to enable a quantum state formed by the second group of quantum bits after the initialization processing to be the first quantum state ρ and take the second group of quantum bits after the initialization processing as the i-th second group of quantum bits.

In one specific example of the present disclosure, the first preset quantum circuit contains nd+1 qubits, in a case where the quantity of the at least one second group of quantum bits is n−1; in an example, the first auxiliary quantum bit is located in a first qubit of the nd+1 qubits; the d quantum bits contained in the first group of quantum bits are located from a second qubit to a (d+1)-th qubit among the nd+1 qubits; and the i-th second group of quantum bits is located from an {id+2}-th qubit to an {(i+1)d+1}-th qubit among the nd+1 qubits.

In one specific example of the present disclosure, the first preset quantum circuit contains nd+1 qubits, in a case where the quantity of the at least one second group of quantum bits is n−1; the first auxiliary quantum bit is located in a first qubit of the nd+1 qubits; the d quantum bits contained in the first group of quantum bits are located from a second qubit to a (d+1)-th qubit among the nd+1 qubits; and the i-th second group of quantum bits is located from an {(n−i)d+2}-th qubit to an {(n−i+1)d+1}-th qubit among the nd+1 qubits.

In one specific example of the present disclosure, in a case where the second quantum operation characterizes a CSWAP gate operation, the second quantum operation unit is specifically configured to perform the CSWAP gate operation on the first auxiliary quantum bit, the first group of quantum bits, and the i-th second group of quantum bits, using the first qubit as a control bit.

In one specific example of the present disclosure, the first high-order quantum state extraction unit is further configured to obtain a measurement result of the first auxiliary quantum bit under a preset calculation base, after the second quantum operation is performed n−1 times, and after the first quantum operation is performed on the first auxiliary quantum bit again; and take the quantum state formed by the current first group of quantum bits as the approximate n-order quantum state ρ^{[n]} of the first quantum state ρ, in a case where the measurement result is a preset result.

The specific function of each unit in the first quantum computing device may be described with reference to the above method, which will not be repeated here.

The present disclosure further provides a second quantum computing device as illustrated in FIG. 11, and the device includes the followings.

A third quantum operation unit 1101 configured to perform a third quantum operation on a second auxiliary quantum bit in a second preset quantum circuit; where the second preset quantum circuit includes at least the second auxiliary quantum bit, a third group of quantum bits and at least one fourth group of quantum bits; the third group of quantum bits forming a second quantum state σ, and a fourth group of quantum bits forming the second quantum state σ.

A fourth quantum operation unit 1102 configured to perform a fourth quantum operation on the second auxiliary quantum bit, the third group of quantum bits and a j-th fourth group of quantum bits in the at least one fourth group of quantum bits, in a case where the third quantum operation is completed; the j being a positive integer greater than or equal to 1 and less than or equal to m−1, and the m being a positive integer greater than or equal to 2.

A second high-order quantum state extraction unit 1103 configured to perform the third quantum operation on the second auxiliary quantum bit again, in a case where the fourth quantum operation is performed m−1 times, and take a quantum state formed by the current third group of quantum bits as an approximate m-order quantum state σ^{[m]} of the second quantum state σ, in a case where the current second auxiliary quantum bit satisfies a preset condition.

In one specific example of the present disclosure, the third quantum operation characterizes a Hadamard gate operation; and/or the fourth quantum operation characterizes a CSWAP gate operation.

In one specific example of the present disclosure, the third group of quantum bits includes b quantum bits, and the fourth group of quantum bits includes b quantum bits; the b being a positive integer greater than or equal to 1.

In one specific example of the present disclosure, the second preset quantum circuit contains 2b+1 qubits, in a case where the quantity of the at least one fourth group of quantum bits is one; in an example, the second auxiliary quantum bit is located in a first qubit of the 2b+1 qubits; the b quantum bits contained in the third group of quantum bits are located from a second qubit to a (b+1)-th qubit among the 2b+1 qubits; and the b quantum bits contained in the fourth group of quantum bits are located in a last b qubits of the 2b+1 qubits.

In one specific example of the present disclosure, in a case where the j is any positive integer from 2 to m−1, the fourth quantum operation unit is further configured to perform initialization processing on quantum bits of the last b qubits in the 2b+1 qubits, to enable a quantum state formed by the fourth group of quantum bits after the initialization processing to be the second quantum state σ and take the fourth group of quantum bits after the initialization processing as the j-th fourth group of quantum bits.

In one specific example of the present disclosure, the second preset quantum circuit contains mb+1 qubits, in a case where the quantity of the at least one fourth group of quantum bits is m−1; in an example, the second auxiliary quantum bit is located in a first qubit of the mb+1 qubits; the b quantum bits contained in the third group of quantum bits are located from a second qubit to a (b+1)-th qubit among the mb+1 qubits; and the j-th fourth group of quantum bits is located from a {jb+2}-th qubit to a {(j+1)b+1}-th qubit among the mb+1 qubits.

In one specific example of the present disclosure, the second preset quantum circuit contains mb+1 qubits, in a case where the quantity of the at least one fourth group of quantum bits is m−1; the second auxiliary quantum bit is located in a first qubit of the mb+1 qubits; the b quantum bits contained in the third group of quantum bits are located from a second qubit to a (b+1)-th qubit among the mb+1 qubits; and the j-th fourth group of quantum bits is located from an {(m−j)b+2}-th qubit to an {(m−j+1)b+1}-th qubit among the mb+1 qubits.

In one specific example of the present disclosure, in a case where the fourth quantum operation characterizes a CSWAP gate operation, the fourth quantum operation unit is specifically configured to perform the CSWAP gate operation on the second auxiliary quantum bit, the third group of quantum bits, and the j-th fourth group of quantum bits, using the first qubit as a control bit.

In one specific example of the present disclosure, the second high-order quantum state extraction unit is further configured to obtain a measurement result of the second auxiliary quantum bit under a preset calculation base, after the fourth quantum operation is performed m−1 times, and after the third quantum operation is performed on the second auxiliary quantum bit again; and take the quantum state formed by the current third group of quantum bits as the approximate m-order quantum state σ^{[m]} of the second quantum state σ, in a case where the measurement result is a preset result.

The specific function of each unit in the second quantum computing device may be described with reference to the above method, which will not be repeated here.

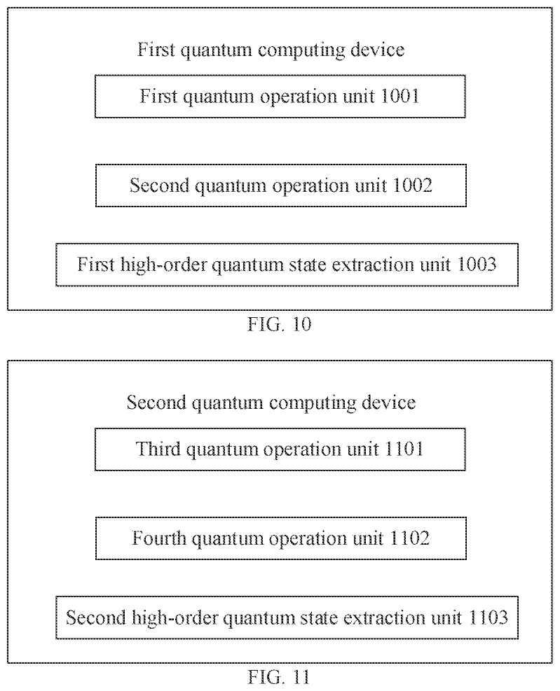

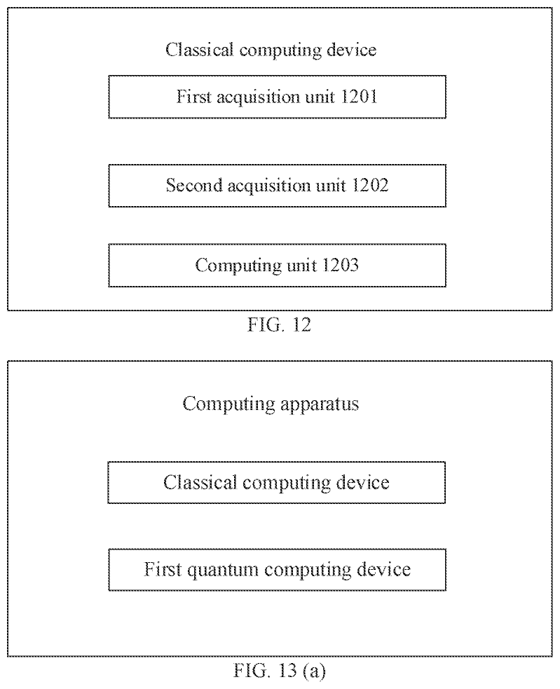

The present disclosure further provides a classical computing device as illustrated in FIG. 12, the classical computing device includes the followings.

A first acquisition unit 1201 configured to acquire a first group of measurement results for a first quantum state ρ, where the first group of measurement results includes a measurement result for the first quantum state ρ and a measurement result for an approximate n-order quantum state ρ^{[n]} of the first quantum state ρ, the approximate n-order quantum state ρ^{[n]} being an approximate high-order quantum state of the first quantum state ρ prepared by a first quantum computing device.

A second acquisition unit 1202 configured to acquire a second group of measurement results for a second quantum state σ, where the second group of measurement results includes a measurement result for the second quantum state σ and a measurement result for an approximate m-order quantum state σ^{[m]} of the second quantum state σ, the approximate m-order quantum state σ^{[m]} being an approximate high-order quantum state of the second quantum state σ prepared by a second quantum computing device.

A computing unit 1203 configured to obtain, based on at least the first group of measurement results and the second group of measurement results, a target high-order inner product tr(ρⁿσ^{m}) for the first quantum state ρ and the second quantum state σ; where the ρⁿ characterizes an n-order quantum state of the first quantum state σ, and the σ^{m} characterizes an m-order quantum state of the second quantum state σ; the n being a positive integer greater than or equal to 2, and the m being a positive integer greater than or equal to 2.

In one specific example of the present disclosure, the computing unit is further configured to obtain, based on the first group of measurement results and the second group of measurement results, at least one of the following calculation results: an inner product tr(ρσ) of the first quantum state ρ and the second quantum state σ; an inner product tr(ρσ^{[m]}) of the first quantum state ρ and the approximate m-order quantum state σ^{[m]}; an inner product tr(ρ^{[n]}σ) of the approximate n-order quantum state and the second quantum state σ; or an inner product tr(ρ^{[n]}σ^{[m]}) of the approximate n-order quantum state ρ^{[n]} and the approximate m-order quantum state σ^{[m]}; and the computing unit is further configured to obtain, based on at least one of the calculation results, the target high-order inner product tr(ρⁿσ^{m}) for the first quantum state ρ and the second quantum state σ.

In one specific example of the present disclosure, the classical computing device further includes a third acquisition unit configured to acquire a first probability feature and a second probability feature; where the first probability feature characterizes a probability feature of the approximate n-order quantum state ρ^{[n]} prepared, and the second probability feature characterizes a probability feature of the approximate m-order quantum state σ^{[m]} prepared; and the computing unit is further configured to obtain, based on the first probability feature, the second probability feature, the first group of measurement results and the second group of measurement results, the target high-order inner product tr(ρⁿσ^{m}) for the first quantum state ρ and the second quantum state σ.

In one specific example of the present disclosure, the computing unit is further configured to obtain, based on at least the target high-order inner product tr(ρⁿσ^{m}), a target distance between the first quantum state ρ and the second quantum state σ.

The specific function of each unit in the classical computing device may be described with reference to the above method, which will not be repeated here.

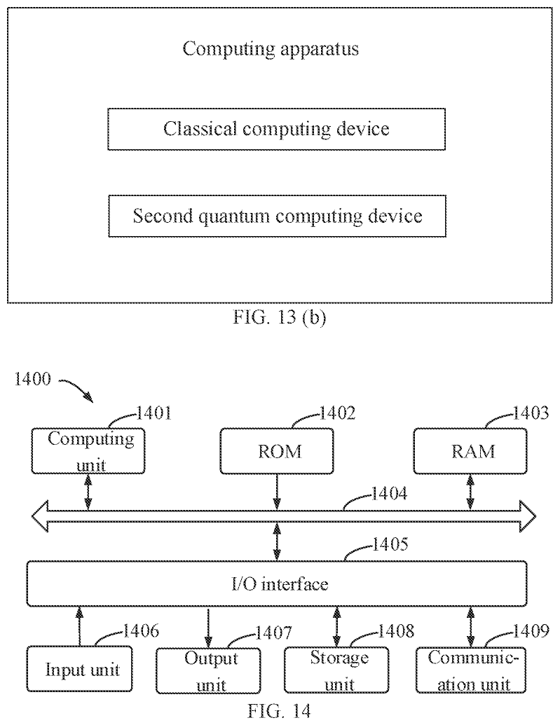

The present disclosure further provides a computing apparatus as illustrated in FIG. 13 (a), including: the first quantum computing device described above and the classical computing device described above; or, as illustrated in FIG. 13 (b), the computing apparatus includes: the second quantum computing device described above and the classical computing device described above.

The present disclosure further provides a non-transitory computer-readable storage medium storing a computer instruction thereon, and the computer instruction, when executed by at least one quantum processing unit, enables the at least one quantum processing unit to execute the above method applied to a first quantum computing device or a second quantum computing device.

The present disclosure further provides a computer program product, including a computer program which implements the above method applied to a classical computing device, when executed by a processor; or the computer program implements the method applied to a first quantum computing device or a second quantum computing device, when executed by at least one quantum processing unit.

The present disclosure further provides a quantum computing device, including: at least one quantum processing unit; and a memory coupled to the at least one quantum processing unit (QPU) and configured to store an executable instruction, in which the instruction, when executed by the at least one quantum processing unit, enables the at least one quantum processing unit to execute the method applied to a first quantum computing device or a second quantum computing device.

It may be understood that the quantum processing unit (QPU) used in the present disclosure may also be called as a quantum processor or a quantum chip, and may involve a physical chip including a plurality of quantum bits interconnected in a specific way.

Moreover, it may be understood that the quantum bit described in the present disclosure may refer to the basic information unit of the quantum computing device. The quantum bits are contained in the QPU, and the concept of classical digital bits is extended.

According to the embodiments of the present disclosure, the present disclosure further provides a classical computing device (specifically an electronic device described as an example below), a readable storage medium and a computer program product.

FIG. 14 illustrates a schematic block diagram of an exemplary electronic device 1400 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components illustrated herein, their connections and relationships as well as their functions are merely examples, and are not intended to limit the implementation of the present disclosure described and/or required herein.

As illustrated in FIG. 14, the electronic device 1400 includes a computing unit 1401 that may perform various appropriate actions and processes according to a computer program stored in a Read-Only Memory (ROM) 1402 or a computer program loaded from a storage unit 1408 into a Random Access Memory (RAM) 1403. Various programs and data required for an operation of the electronic device 1400 may also be stored in the RAM 1403. The computing unit 1401, the ROM 1402 and the RAM 1403 are connected to each other through a bus 1404. An input/output (I/O) interface 1405 is also connected to the bus 1404.

A plurality of components in the electronic device 1400 are connected to the I/O interface 1405, and include an input unit 1406 such as a keyboard, a mouse, and the like; an output unit 1407 such as various types of displays, speakers, and the like; a storage unit 1408 such as a magnetic disk, an optical disk, and the like; and a communication unit 1409 such as a network card, a modem, a wireless communication transceiver, and the like. The communication unit 1409 allows the electronic device 1400 to exchange information/data with other devices through a computer network such as Internet and/or various telecommunication networks.

The computing unit 1401 may be various general-purpose and/or special-purpose processing component with processing and computing capabilities. Some examples of the computing unit 1401 include, but are not limited to, a Central Processing Unit (CPU), a Graphics Processing Unit (GPU), various dedicated Artificial Intelligence (AI) computing chips, various computing units running machine learning model algorithms, a Digital Signal Processor (DSP), and any appropriate processors, controllers, microcontrollers, and the like. The computing unit 1401 performs various methods and processes described above, for example, a quantum state processing method applied to a classical computing device. For example, in some implementations, the quantum state processing method applied to a classical computing device may be implemented as a computer software program, which is tangibly contained in a machine-readable medium, such as the storage unit 1408. In some implementations, a part or all of the computer program may be loaded and/or installed on the electronic device 1400 via the ROM 1402 and/or the communication unit 1409. When the computer program is loaded into RAM 1403 and executed by the computing unit 1401, one or more steps of the quantum state processing method applied to the classical computing device described above may be performed. Alternatively, in other implementations, the computing unit 1401 may be configured to perform the quantum state processing method applied to a classical computing device by any other suitable way (e.g., by means of firmware).

Various implementations of the systems and technologies described above herein may be implemented in a digital electronic circuit system, an integrated circuit system, a Field Programmable Gate Array (FPGA), an Application Specific Integrated Circuit (ASIC), an Application Specific Standard Parts (ASSP), a System on Chip (SOC), a Complex Programmable Logic Device (CPLD), a computer hardware, firmware, software, and/or a combination thereof. These various implementations may include implementing in one or more computer programs that may be executed and/or interpreted on a programmable system including at least one programmable processor. The programmable processor may be a special-purpose or general-purpose programmable processor, and may receive data and instructions from a storage system, at least one input device, and at least one output device, and transmit data and instructions to the storage system, the at least one input device, and the at least one output device.

The program code for implementing the methods of the present disclosure may be written in any combination of one or more programming languages. These program codes may be provided to the processor or controller of general-purpose computer, special-purpose computer or other programmable data processing device, so that when being executed by the processor or controller, the program code enables the functions/operations specified in the flow chart and/or block diagram to be implemented. The program code may be executed completely on a machine, partially on a machine, partially on a machine and partially on a remote machine, or completely on a remote machine or server as a separate software package.

In the context of the present disclosure, a machine-readable medium may be a tangible medium that may contain or store programs for use by or in combination with an instruction execution system, device, or equipment. The machine-readable medium may be machine-readable signal medium or machine-readable storage medium. The machine readable medium may include, but are not limited to, electronic, magnetic, optical, electromagnetic, infrared, or semiconductor systems, devices, or equipment, or any suitable combination of the above. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disk Read-Only Memory (CD-ROM), an optical storage device, a magnetic storage device, or any suitable combination of the above.

In order to provide interaction with a user, the systems and technologies described herein may be implemented on a computer. The computer has a display device (e.g., a cathode ray tube (CRT) or a Liquid Crystal Display (LCD) monitor) for displaying information to the user and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and it is capable of receiving input from the user in any form (including an acoustic input, a voice input, or a tactile input).

The systems and technologies described herein may be implemented in a computing system that includes a back-end component (e.g., as a data server), a computing system that includes a middleware component (e.g., as an application server), a computing system that includes a front-end component (e.g., as a user computer with a graphical user interface or web browser through which the user may interact with the implementation of the systems and technologies described herein), or a computing system that includes any combination of the back-end component, the middleware component, or the front-end component. The components of the system may be connected each other through any form or kind of digital data communication (e.g., a communication network). Examples of the communication network include a Local Area Network (LAN), a Wide Area Network (WAN), and Internet.

A computer system may include a client and a server. The client and server are generally far away from each other and usually interact through a communication network. The server may also be a server of a distributed system or a server combined with a blockchain, and the relationship between the client and the server is generated through computer programs performed on a corresponding computer and having a client-server relationship with each other.

It should be understood that various forms of processes illustrated above may be used to reorder, add or delete steps. For example, steps described in the present disclosure may be executed in parallel, sequentially, or in a different order, as long as the desired result of the technical solution disclosed in the present disclosure may be achieved, but is not limited herein.

The foregoing specific implementations do not constitute a limitation to the protection scope of the present disclosure. Those having ordinary skill in the art should understand that various modifications, combinations, sub-combinations and substitutions may be made according to design requirements and other factors. Any modification, equivalent replacement and improvement made within the spirit and principle of the present disclosure should be included in the protection scope of the present disclosure.

What is claimed is:

1. A quantum state processing method, applied to a first quantum computing device, comprising:
performing a first quantum operation on a first auxiliary quantum bit in a first preset quantum circuit; wherein the first preset quantum circuit comprises at least the first auxiliary quantum bit, a first group of quantum bits and at least one second group of quantum bits; the first group of quantum bits forming a first quantum state ρ, and a second group of quantum bits forming the first quantum state ρ;
performing a second quantum operation on the first auxiliary quantum bit, the first group of quantum bits and an i-th second group of quantum bits in the at least one second group of quantum bits, in a case where the first quantum operation is completed; the i being a positive integer greater than or equal to 1 and less than or equal to n−1, and the n being a positive integer greater than or equal to 2; and
performing the first quantum operation on the first auxiliary quantum bit again, in a case where the second quantum operation is performed n−1 times, and taking a quantum state formed by the current first group of quantum bits as an approximate n-order quantum state ρ^{[n]} of the first quantum state ρ, in a case where the current first auxiliary quantum bit satisfies a preset condition.

2. The method of claim 1, wherein the first quantum operation characterizes a Hadamard gate operation; and/or the second quantum operation characterizes a control swapping (CSWAP) gate operation.

3. The method of claim 1, wherein the first group of quantum bits comprises d quantum bits, and the second group of quantum bits comprises d quantum bits; the d being a positive integer greater than or equal to 1.

4. The method of claim 3, wherein
the first preset quantum circuit contains 2d+1 qubits, in a case where a quantity of the at least one second group of quantum bits is one; wherein the first auxiliary quantum bit is located in a first qubit of the 2d+1 qubits; the d quantum bits contained in the first group of quantum bits are located from a second qubit to a (d+1)-th qubit among the 2d+1 qubits; and the d quantum bits contained in the second group of quantum bits are located in last d qubits of the 2d+1 qubits; or
the first preset quantum circuit contains nd+1 qubits, in a case where a quantity of the at least one second group of quantum bits is n−1; wherein the first auxiliary quantum bit is located in a first qubit of the nd+1 qubits; the d quantum bits contained in the first group of quantum bits are located from a second qubit to a (d+1)-th qubit among the nd+1 qubits; and the i-th second group of quantum bits is located from an {id+2}-th qubit to an {(i+1)d+1}-th qubit among the nd+1 qubits; or
the first preset quantum circuit contains nd+1 qubits, in a case where a quantity of the at least one second group of quantum bits is n−1; wherein the first auxiliary quantum bit is located in a first qubit of the nd+1 qubits; the d quantum bits contained in the first group of quantum bits are located from a second qubit to a (d+1)-th qubit among the nd+1 qubits; and the i-th second group of quantum bits is located from an {(n−i)d+2}-th qubit to an {(n−i+1)d+1}-th qubit among the nd+1 qubits.

5. The method of claim 4, wherein in a case where the quantity of the at least one second group of quantum bits is one, the first preset quantum circuit contains 2d+1 qubits and the i is any positive integer from 2 to n−1, the method further comprises:
performing initialization processing on quantum bits of the last d qubits in the 2d+1 qubits, to enable a quantum state formed by the second group of quantum bits after the initialization processing to be the first quantum state ρ and take the second group of quantum bits after the initialization processing as the i-th second group of quantum bits.

6. The method of claim 4, wherein performing the second quantum operation on the first auxiliary quantum bit, the first group of quantum bits and the i-th second group of quantum bits in the at least one second group of quantum bits, in a case where the second quantum operation characterizes a control swapping (CSWAP) gate operation, comprises:
performing the control swapping (CSWAP) gate operation on the first auxiliary quantum bit, the first group of quantum bits, and the i-th second group of quantum bits, using the first qubit as a control bit.

7. The method of claim 1, further comprising:
obtaining a measurement result of the first auxiliary quantum bit under a preset calculation base, after the second quantum operation is performed n−1 times, and after the first quantum operation is performed on the first auxiliary quantum bit again;
wherein taking the quantum state formed by the current first group of quantum bits as the approximate n-order quantum state ρ^{[n]} of the first quantum state ρ, in the case where the current first auxiliary quantum bit satisfies the preset condition, comprises:
taking the quantum state formed by the current first group of quantum bits as the approximate n-order quantum state ρ^{[n]} of the first quantum state ρ, in a case where the measurement result is a preset result.

8. A quantum state processing method, applied to a second quantum computing device, comprising:
performing a third quantum operation on a second auxiliary quantum bit in a second preset quantum circuit; wherein the second preset quantum circuit comprises at least the second auxiliary quantum bit, a third group of quantum bits and at least one fourth group of quantum bits; the third group of quantum bits forming a second quantum state σ, and a fourth group of quantum bits forming the second quantum state σ;
performing a fourth quantum operation on the second auxiliary quantum bit, the third group of quantum bits and a j-th fourth group of quantum bits in the at least one fourth group of quantum bits, in a case where the third quantum operation is completed; the j being a positive integer greater than or equal to 1 and less than or equal to m−1, and the m being a positive integer greater than or equal to 2; and
performing the third quantum operation on the second auxiliary quantum bit again, in a case where the fourth quantum operation is performed m−1 times, and taking a quantum state formed by the current third group of quantum bits as an approximate m-order quantum state σ^{[m]} of the second quantum state σ, in a case where the current second auxiliary quantum bit satisfies a preset condition.

9. The method of claim 8, wherein the third quantum operation characterizes a Hadamard gate operation; and/or the fourth quantum operation characterizes a control swapping (CSWAP) gate operation.

10. The method of claim 8, wherein the third group of quantum bits comprises b quantum bits, and the fourth group of quantum bits comprises b quantum bits; the b being a positive integer greater than or equal to 1.

11. The method of claim 10, wherein
the second preset quantum circuit contains 2b+1 qubits, in a case where a quantity of the at least one fourth group of quantum bits is one; wherein the second auxiliary quantum bit is located in a first qubit of the 2b+1 qubits; the b quantum bits contained in the third group of quantum bits are located from a second qubit to a (b+1)-th qubit among the 2b+1 qubits; and the b quantum bits contained in the fourth group of quantum bits are located in last b qubits of the 2b+1 qubits; or
the second preset quantum circuit contains mb+1 qubits, in a case where a quantity of the at least one fourth group of quantum bits is m−1; wherein the second auxiliary quantum bit is located in a first qubit of the mb+1 qubits; the b quantum bits contained in the third group of quantum bits are located from a second qubit to a (b+1)-th qubit among the mb+1 qubits; and the j-th fourth group of quantum bits is located from a {jb+2}-th qubit to a {(j+1)b+1}-th qubit among the mb+1 qubits; or
the second preset quantum circuit contains mb+1 qubits, in a case where a quantity of the at least one fourth group of quantum bits is m−1; wherein the second auxiliary quantum bit is located in a first qubit of the mb+1 qubits; the b quantum bits contained in the third group of quantum bits are located from a second qubit to a (b+1)-th qubit among the mb+1 qubits; and the j-th fourth group of quantum bits is located from an {(m−j)b+2}-th qubit to an {(m−j+1)b+1}-th qubit among the mb+1 qubits.

12. The method of claim 11, wherein in a case where the quantity of the at least one fourth group of quantum bits is one, the second preset quantum circuit contains 2b+1 qubits, and the j is any positive integer from 2 to m−1, the method further comprises:
performing initialization processing on quantum bits of the last b qubits in the 2b+1 qubits, to enable a quantum state formed by the fourth group of quantum bits after the initialization processing to be the second quantum state σ and take the fourth group of quantum bits after the initialization processing as the j-th fourth group of quantum bits.

13. The method of claim 11, wherein performing the fourth quantum operation on the second auxiliary quantum bit, the third group of quantum bits and the j-th fourth group of quantum bits in the at least one fourth group of quantum bits, in a case where the fourth quantum operation characterizes a control swapping (CSWAP) gate operation, comprises:
performing the control swapping (CSWAP) gate operation on the second auxiliary quantum bit, the third group of quantum bits, and the j-th fourth group of quantum bits, using the first qubit as a control bit.

14. The method of claim 8, further comprising:
obtaining a measurement result of the second auxiliary quantum bit under a preset calculation base, after the fourth quantum operation is performed m−1 times, and after the third quantum operation is performed on the second auxiliary quantum bit again;
wherein taking the quantum state formed by the current third group of quantum bits as the approximate m-order quantum state σ^{[m]} of the second quantum state σ, in the case where the current second auxiliary quantum bit satisfies the preset condition, comprises:
taking the quantum state formed by the current third group of quantum bits as the approximate m-order quantum state σ^{[m]} of the second quantum state σ, in a case where the measurement result is a preset result.

15. A quantum state processing method, applied to a classical computing device, comprising:
acquiring, by the classical computing device, a first group of measurement results for a first quantum state ρ, wherein the first group of measurement results comprises a measurement result for the first quantum state ρ and a measurement result for an approximate n-order quantum state ρ^{[n]} of the first quantum state ρ, the approximate n-order quantum state ρ^{[n]} being an approximate high-order quantum state of the first quantum state ρ prepared by a first quantum computing device;
acquiring, by the classical computing device, a second group of measurement results for a second quantum state σ, wherein the second group of measurement results comprises a measurement result for the second quantum state σ and a measurement result for an approximate m-order quantum state σ^{[m]} of the second quantum state σ, the approximate m-order quantum state σ^{[m]} being an approximate high-order quantum state of the second quantum state σ prepared by a second quantum computing device; and
obtaining, by the classical computing device, based on at least the first group of measurement results and the second group of measurement results, a target high-order inner product tr(ρⁿσ^{m}) for the first quantum state ρ and the second quantum state σ; wherein the ρⁿ characterizes an n-order quantum state of the first quantum state σ, and the σ^{m} characterizes an m-order quantum state of the second quantum state σ; the n being a positive integer greater than or equal to 2, and the m being a positive integer greater than or equal to 2.

16. The method of claim 15, further comprising:
obtaining, by the classical computing device, based on the first group of measurement results and the second group of measurement results, at least one of the following calculation results:
an inner product tr(ρσ) of the first quantum state ρ and the second quantum state σ;
an inner product tr(ρσ^{[m]}) of the first quantum state ρ and the approximate m-order quantum state σ^{[m]};
an inner product tr(ρ^{[n]}σ^{[m]}) of the approximate n-order quantum state and the second quantum state σ; or
an inner product tr(ρ^{[n]}σ^{[m]}) of the approximate n-order quantum state ρ^{[n]} and the approximate m-order quantum state σ^{[m]};
wherein obtaining, based on at least the first group of measurement results and the second group of measurement results, the target high-order inner product tr(ρⁿσ^{m}) for the first quantum state ρ and the second quantum state σ, comprises:
obtaining, based on at least one of the calculation results, the target high-order inner product tr(ρⁿσ^{m}) for the first quantum state ρ and the second quantum state σ.

17. The method of claim 15, further comprising:
acquiring a first probability feature and a second probability feature; wherein the first probability feature characterizes a probability feature of the approximate n-order quantum state ρ^{[n]} prepared, and the second probability feature characterizes a probability feature of the approximate m-order quantum state σ^{[m]} prepared;
wherein obtaining, based on at least the first group of measurement results and the second group of measurement results, the target high-order inner product tr(ρⁿσ^{m}) for the first quantum state ρ and the second quantum state σ, comprises:
obtaining, based on the first probability feature, the second probability feature, the first group of measurement results and the second group of measurement results, the target high-order inner product tr(ρⁿσ^{m}) for the first quantum state ρ and the second quantum state σ.

18. The method of claim 15, further comprising:
obtaining, based on at least the target high-order inner product tr(ρⁿσ^{m}), a target distance between the first quantum state ρ and the second quantum state σ.

19. A classical computing device, comprising:
at least one processor; and
a memory connected in communication with the at least one processor,
wherein the memory stores an instruction executable by the at least one processor, and the instruction, when executed by the at least one processor, enables the at least one processor to execute the method of claim 15.

20. A non-transitory computer-readable storage medium storing a computer instruction thereon, wherein the computer instruction is used to cause a computer to execute the method of claim 15.
